(19) United States
(12) Patent Application Publication
(10) Pub. No.: US 2025/0039898 A1
(43) Pub. Date: Jan. 30, 2025

(54) METHOD AND DEVICE IN NODES USED FOR WIRELESS COMMUNICATION

(71) Applicants: Lu WU, Shanghai (CN); Shengnan XU, Shanghai (CN); Xiaobo ZHANG, Shanghai (CN)

(72) Inventors: Lu WU, Shanghai (CN); Shengnan XU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/783,393

(22) Filed: Jul. 24, 2024

(30) Foreign Application Priority Data
Jul. 28, 2023 (CN) 202310943828.X
Oct. 23, 2023 (CN) 202311380409.6

(51) Int. Cl. H04W 72/231; H04B 7/06; H04L 5/00; H04W 72/0446; H04W 76/20

(52) U.S. Cl. CPC H04W 72/231; H04B 7/06968; H04L 5/0051; H04W 72/0446; H04W 76/20

(57) ABSTRACT

A first receiver receives a second information block, the second information block being used to determine that a first search space set is linked to a second search space set and a third search space set; receives a first information block, the first information block being used to determine a reference time-domain resource set; and monitors in a first time unit at least first PDCCH candidate in the first search space set and at least target PDCCH candidate in a target search space set; where the first PDCCH candidate and the target PDCCH candidate are monitored to detect DCI format with identical information; whether the target search space set is the second search space set or the third search space set depends on whether the first time unit and the reference time-domain resource set are orthogonal. This application reduces interference and enhances the system flexibility.

### CROSS REFERENCE TO RELATED APPLICATIONS

This application claims the priority benefit of Chinese Patent Application No. 202311380409.6, filed on Oct. 23, 2023, and claims the priority benefit of Chinese Patent Application No. 202310943828.X, filed on Jul. 28, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In existing New Radio (NR) systems, spectrum resources are divided into Frequency Division Duplexing (FDD) spectrum and Time Division Duplexing (TDD) spectrum. For TDD spectrum, both the base station and UE (i.e., User Equipment) operate in half-duplex mode. Such Half Duplex Mode avoids self-interference and reduces the influence of Cross Link interference, but it also brings about a reduction of resource utilization ratio and a longer delay. In view of these problems, to support flexible duplex mode or variable link directions (Uplink, or Downlink, or Flexible ones) on the TDD spectrum or the FDD spectrum becomes a potential solution. In the 3rd Generation Partner Project (3GPP) Radio Access Network (RAN) #88e meeting and the 3GPP Release-18 (also referred to as R-18) workshop, the support of more flexible duplex mode or full duplex mode in NR R-18 has been widely noticed and discussed, especially the SubBand non-overlapping Full Duplex (SBFD) mode at the gNB (NR node B) end. In this mode, the same symbol will be used for uplink in a portion of the frequency resources and for downlink in the other portion of the frequency resources, so that resource utilization is improved and delay is reduced.

### SUMMARY

Inventors have found through the research that how to determine the search space sets being linked is a key problem.

To address the above problem, the present application provides a solution. It is to be noted that in the description of the present application, only the more flexible duplex mode, full duplex mode and SBFD mode are used as examples, and the present application can be applied to other duplex mode scenarios as well, and further, for different scenarios (including, but not limited to, the more flexible duplex mode, the full duplex mode, the SBFD mode, the half-duplex mode, the conventional duplex mode, the network energy-saving mode, the non-energy-saving mode, etc.) Adopting a unified design scheme also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a second information block, the second information block being used to determine that a first search space set is linked to a second search space set and a third search space set; and
receiving a first information block, the first information block being used to determine a reference time-domain resource set; and
monitoring in a first time unit at least a first Physical Downlink Control Channel (PDCCH) candidate in the first search space set and at least a target PDCCH candidate in a target search space set;
herein, the first PDCCH candidate and the target PDCCH candidate are monitored to detect a DCI (i.e., Downlink Control Information) format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, a problem to be solved in the present application includes: how to determine a target search space set linked to the first search space set.

In one embodiment, an advantage of the above method includes: configuring multiple search space sets connected to the first search space set, and determining one of them as a target search space set based on the time unit in which it is located, thus improving the flexibility of the system.

In one embodiment, an advantage of the above method includes: providing a more appropriate target search space set in different time-domain resources or symbols of different duplex types, improving the performance of monitoring the PDCCH candidates.

In one embodiment, an advantage of the above method includes: simplifying changes made to the configuration of search space sets linked together in the standard, thereby reducing signaling overhead.

According to one aspect of the present application, characterized in that when the first time unit belongs to the reference time-domain resource set, the target search space set is the third search space set.

According to one aspect of the present application, characterized in that when PDCCH monitoring occasion(s) of the second search space set in the first time unit belongs/belong to the reference time-domain resource set, the target search space set is the third search space set.

According to one aspect of the present application, characterized in that when a PDCCH monitoring occasion in which the at least first PDCCH candidate in the first search space set is monitored in the first time unit belongs to the reference time-domain resource set, the target search space set is the third search space set.

In one embodiment, an advantage of the above method includes: increasing the configuration flexibility.

According to one aspect of the present application, characterized in that in the first time unit, PDCCH candidates in a search space set of the second search space set and the third search space set other than the target search space set and PDCCH candidates in the first search space set are not monitored to detect a DCI format with identical information.

In one embodiment, an advantage of the above method includes: reducing the implementation complexity.

According to one aspect of the present application, characterized in that in the first time unit, monitoring of the PDCCH candidates is dropped in a search space set of the second search space set and the third search space set other than the target search space set.

In one embodiment, an advantage of the above method includes: reducing requirements for the UE's capability to monitor PDCCH candidates.

According to one aspect of the present application, characterized in that the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set.

In one embodiment, an advantage of the above method includes: being easy to implement and requiring only small changes to the standard.

According to one aspect of the present application, characterized in comprising:
receiving a third information block;
herein, the third information block indicates configuration information of a first Control Resource Set (CORESET); the first CORESET is associated with the first search space set, and the configuration information of the first CORESET includes two Transmission Configuration Indicator (TCI) states; the two TCI states in the configuration information of the first CORESET respectively indicate quasi co-location (QCL) information for a DMRS (i.e., Demodulation Reference Signal) antenna port for PDCCH reception in the first CORESET outside of the reference time-domain resource set and QCL information for a DMRS antenna port for PDCCH reception in the first CORESET in the reference time-domain resource set.

In one embodiment, an advantage of the above method includes: the configuration information of the first CORESET including two TCI states, which enables the flexibility of adopting a suitable TCI state as needed, thus enhancing flexibility.

In one embodiment, an advantage of the above method includes: providing different QCL information outside of the reference time-domain resource set and within the reference time-domain resource set, enhancing flexibility and reliability of PDCCH reception.

According to one aspect of the present application, characterized in that the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission.

In one embodiment, an advantage of the above method includes: supporting uplink transmission over DL symbols, increasing uplink capacity, improving resource utilization, and reducing latency.

The present application provides a method in a second node for wireless communications, comprising:
transmitting a second information block, the second information block being used to determine that a first search space set is linked to a second search space set and a third search space set; and
transmitting a first information block, the first information block being used to determine a reference time-domain resource set;
herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

According to one aspect of the present application, characterized in that when the first time unit belongs to the reference time-domain resource set, the target search space set is the third search space set.

According to one aspect of the present application, characterized in that when PDCCH monitoring occasion(s) of the second search space set in the first time unit belongs/belong to the reference time-domain resource set, the target search space set is the third search space set.

According to one aspect of the present application, characterized in that when a PDCCH monitoring occasion in which the at least first PDCCH candidate in the first search space set is monitored in the first time unit belongs to the reference time-domain resource set, the target search space set is the third search space set.

According to one aspect of the present application, characterized in that in the first time unit, PDCCH candidates in a search space set of the second search space set and the third search space set other than the target search space set and PDCCH candidates in the first search space set are not monitored to detect a DCI format with identical information.

According to one aspect of the present application, characterized in that in the first time unit, monitoring of the PDCCH candidates is dropped in a search space set of the second search space set and the third search space set other than the target search space set.

According to one aspect of the present application, characterized in that the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set.

According to one aspect of the present application, characterized in comprising:
transmitting a third information block;
herein, the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside of the reference time-domain resource set and QCL information for a DMRS antenna port for PDCCH reception in the first CORESET in the reference time-domain resource set.

According to one aspect of the present application, characterized in that the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission.

According to one aspect of the present application, characterized in that two types of symbols are both configured as DL by higher layer parameter(s), the reference time-domain resource set including only one type of symbols of the two types of symbols.

The present application provides a first node for wireless communications, comprising:
a first receiver, receiving a second information block, the second information block being used to determine that a first search space set is linked to a second search space set and a third search space set;
the first receiver, receiving a first information block, the first information block being used to determine a reference time-domain resource set;
the first receiver, monitoring in a first time unit at least first PDCCH candidate in the first search space set and at least target PDCCH candidate in a target search space set;
herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

The present application provides a second node for wireless communications, comprising:
a second transmitter, transmitting a second information block, the second information block being used to determine that a first search space set is linked to a second search space set and a third search space set;
the second transmitter, transmitting a first information block, the first information block being used to determine a reference time-domain resource set;
herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, compared with the prior art, the present application is advantageous in the following aspects:
improved performance in monitoring PDCCH candidates;
improved system flexibility and reduced signaling overhead;
reduced implementation complexity;
only small changes to the standard being required;
reduced link interference and reduced latency.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a second information block and a first information block according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6A-FIG. 6C each illustrate a schematic diagram of a target search space set being a third search space set according to one embodiment of the present application.

FIG. 7 illustrates a schematic diagram of a PDCCH candidate not being monitored to detect a DCI format with identical information according to one embodiment of the present application.

FIG. 8 illustrates a schematic diagram of monitoring of PDCCH candidate being dropped according to one embodiment of the present application.

FIG. 9 illustrates a schematic diagram of a first-type parameter according to one embodiment of the present application.

FIG. 10 illustrates a schematic diagram of a third information block according to one embodiment of the present application.

FIG. 11A-FIG. 11B each illustrate a schematic diagram of a reference time-domain resource set and two types of symbols according to one embodiment of the present application.

FIG. 12 illustrates a structure block diagram of a processing device in a first node according to one embodiment of the present application.

FIG. 13 illustrates a structure block diagram a processing device in a second node according to one embodiment of the present application.

### DESCRIPTION OF THE EMBODIMENTS

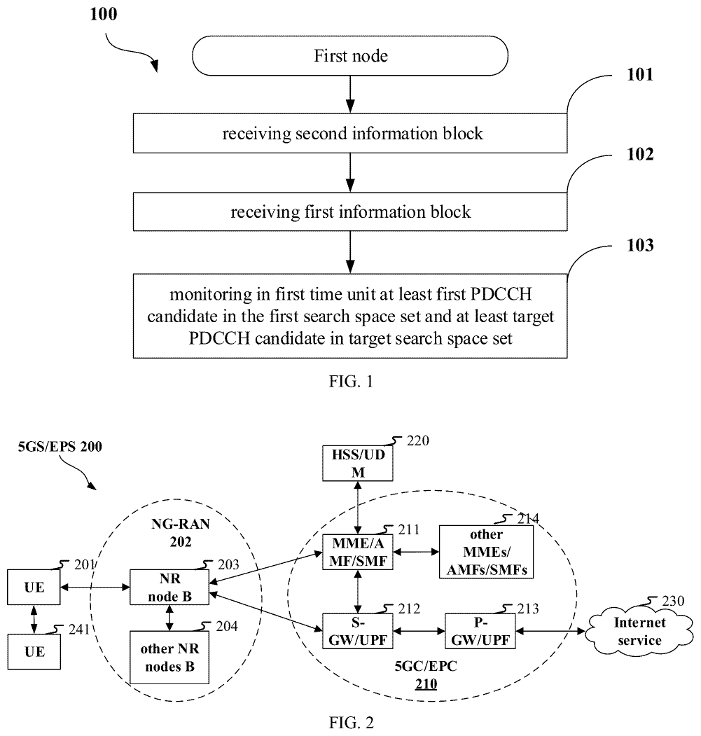

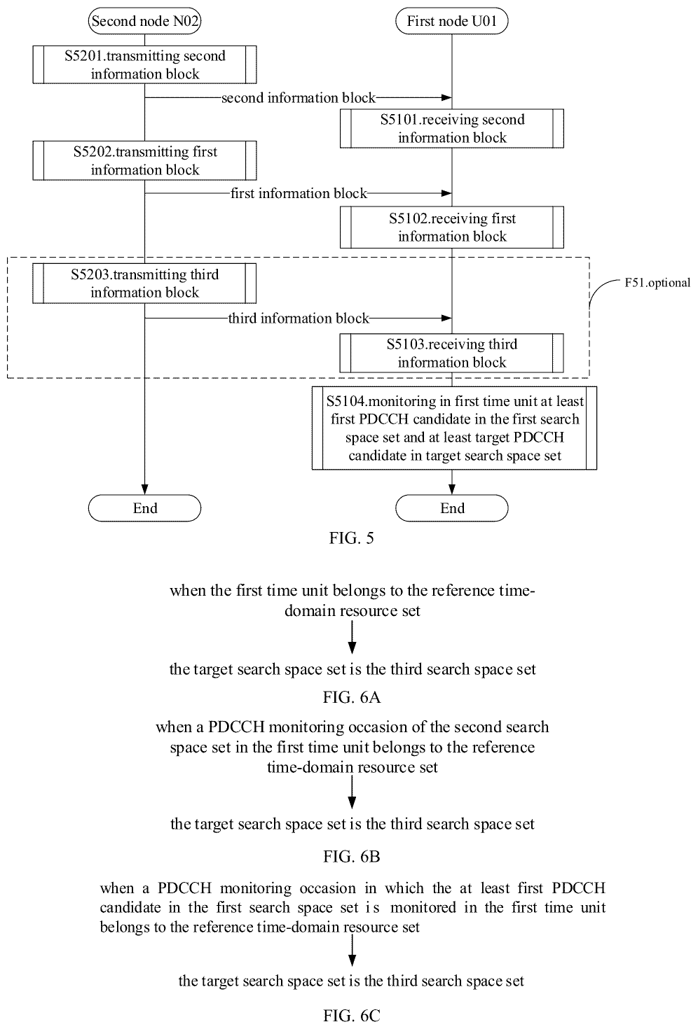

The technical scheme of the present application is described below in further details in conjunction with the drawings. It should be noted that the embodiments of the present application and the characteristics of the embodiments may be arbitrarily combined if no conflict is caused. Based on considerations of flexibility, complexity, overhead, and compatibility, the person skilled in the art is motivated to flexibly combine embodiments in different accompanying drawings without contradicting each other, such as (but not limited to) embodiments in FIG. 1 and embodiments in FIG. 5-FIG. 11B, embodiments in FIG. 5 and embodiments in FIG. 6-FIG. 11B, and so forth.

### Embodiment 1

Embodiment 1 illustrates a flowchart of a second information block and a first information block according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application receives a second information block in step 101, the second information block being used to determine that a first search space set is linked to a second search space set and a third search space set; and receives a first information block in step 102, the first information block being used to determine a reference time-domain resource set; and in step 103, monitors in a first time unit at least first PDCCH candidate in the first search space set and at least target PDCCH candidate in a target search space set; herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the second information block is carried by a higher layer signaling.

In one embodiment, the second information block is carried by a Radio Resource Control (RRC) signaling.

In one embodiment, the second information block comprises information in all or partial fields in an RRC Information Element (IE).

In one embodiment, the second information block comprises information in all or partial fields in each one of multiple RRC IEs.

In one embodiment, the second information block comprises information in all or partial fields in an RRC IE that includes “SearchSpace” in its name.

In one embodiment, the second information block comprises information in all or partial fields in an IE SearchSpace.

In one embodiment, the second information block comprises information in all or partial fields in each one of multiple IEs SearchSpace.

In one embodiment, the second information block comprises information in all or partial fields in each one of three IEs SearchSpace.

In one embodiment, the second information block comprises a field in an IE SearchSpace whose name includes “searchSpaceLinking”.

In one embodiment, the second information block comprises a field searchSpaceLinkingId in an IE SearchSpace.

In one embodiment, the second information block comprises a field in each one of multiple IEs SearchSpace whose name includes “searchSpaceLinking”.

In one embodiment, the second information block comprises a field searchSpaceLinkingId in each one of multiple IEs SearchSpace.

In one embodiment, a field searchSpaceLinkingId has the same value in each one of multiple IEs SearchSpace comprised in the second information block.

In one embodiment, the second information block comprises a field in each one of three IEs SearchSpace whose name includes “searchSpaceLinking”.

In one embodiment, the second information block comprises a field searchSpaceLinkingId in each one of three IEs SearchSpace.

In one embodiment, a field searchSpaceLinkingId has the same value in each one of three IEs SearchSpace comprised in the second information block.

In one embodiment, the second information block comprises one or more RRC IEs.

In one embodiment, the second information block comprises one or more IEs SearchSpace.

In one embodiment, the second information block comprises multiple IEs SearchSpace.

In one embodiment, the second information block comprises three IEs SearchSpace.

In one embodiment, each IE SearchSpace of three IEs SearchSpace included in the second information block comprises a field searchSpaceLinkingId.

In one embodiment, each IE SearchSpace of three IEs SearchSpace included in the second information block comprises a field searchSpaceLinkingId, with the respective searchSpaceLinkingId fields having the same value.

In one embodiment, the specific definitions of the IE SearchSpace and the field searchSpaceLinkingId can be found in 3GPP TS 38.331, Section 6.3.2.

In one embodiment, the second information block comprises configuration information of the first search space set, configuration information of the second search space set and configuration information of the third search space set.

In one embodiment, the second information block comprises three RRC IEs, the three RRC IEs respectively comprising configuration information of the first search space set, configuration information of the second search space set and configuration information of the third search space set.

In one embodiment, the second information block comprises three IEs SearchSpace, the three IEs SearchSpace respectively comprising configuration information of the first search space set, configuration information of the second search space set and configuration information of the third search space set.

In one embodiment, the configuration information of a search space set comprises: a search space set index, an index of an associated CORESET, a periodicity and offset of PDCCH monitoring, a pattern of PDCCH monitoring within a slot, the number of slots present in the search space set or in consecutive groups of slots, a bitmap indicating the slots in a group of slots used for PDCCH monitoring, the number of PDCCH candidates per CCE (i.e., Control Channel Element) aggregation level, a search space type indication, and an indication of a link to another search space set.

In one embodiment, the configuration information of one search space set is specified in Section 10.1 of 3GPP TS 38.213.

In one embodiment, a searchSpaceId field in an IE SearchSpace included in the second information block configures a search space set index.

In one embodiment, a controlResourceSetId field in an IE SearchSpace included in the second information block configures an index of an associated CORESET.

In one embodiment, a monitoringSlotPeriodicityAndOffset field in an IE SearchSpace included in the second information block configures the periodicity and offset for PDCCH monitoring.

In one embodiment, a monitoringSymbolsWithinSlot field in an IE SearchSpace included in the second information block configures a PDCCH monitoring mode within a slot.

In one embodiment, a duration field in an IE SearchSpace included in the second information block configures the number of slots present in a search space set or the number of slots in consecutive slot groups.

In one embodiment, a monitoringSlotsWithinSlotGroup field in an IE SearchSpace included in the second information block configures a bitmap indicative of slots in a slot group for PDCCH monitoring.

In one embodiment, a nrofCandidates field in an IE SearchSpace included in the second information block configures a number of PDCCH candidates per CCE aggregation level.

In one embodiment, a searchSpaceType field in an IE SearchSpace included in the second information block configures a search space type indication.

In one embodiment, a searchSpaceLinkingId field in an IE SearchSpace included in the second information block configures an indication of a link to another search space set.

In one embodiment, the configuration information of the first search space set comprises some or all of the configuration information of the one search space set.

In one embodiment, the configuration information of the first search space set comprises at least a search space set index in the configuration information of the one search space set.

In one embodiment, the configuration information of the first search space set comprises at least an indication of a link to another search space set in the configuration information of the one search space set.

In one embodiment, the configuration information of the first search space set comprises at least a search space set index and an indication of a link to another search space set in the configuration information of the one search space set.

In one embodiment, the configuration information of the first search space set comprises at least a search space set index and an index of an associated CORESET in the configuration information of the one search space set.

In one embodiment, the configuration information of the first search space set comprises at least a search space set index, an index of an associated CORESET and an indication of a link to another search space set in the configuration information of the one search space set.

In one embodiment, the configuration information of the second search space set comprises some or all of the configuration information of the one search space set.

In one embodiment, the configuration information of the second search space set comprises at least a search space set index in the configuration information of the one search space set.

In one embodiment, the configuration information of the second search space set comprises at least an indication of a link to another search space set in the configuration information of the one search space set.

In one embodiment, the configuration information of the second search space set comprises at least a search space set index and an indication of a link to another search space set in the configuration information of the one search space set.

In one embodiment, the configuration information of the second search space set comprises at least a search space set index and an index of an associated CORESET in the configuration information of the one search space set.

In one embodiment, the configuration information of the second search space set comprises at least a search space set index, an index of an associated CORESET and an indication of a link to another search space set in the configuration information of the one search space set.

In one embodiment, the configuration information of the third search space set comprises some or all of the configuration information of the one search space set.

In one embodiment, the configuration information of the third search space set comprises at least a search space set index in the configuration information of the one search space set.

In one embodiment, the configuration information of the third search space set comprises at least an indication of a link to another search space set in the configuration information of the one search space set.

In one embodiment, the configuration information of the third search space set comprises at least a search space set index and an indication of a link to another search space set in the configuration information of the one search space set.

In one embodiment, the configuration information of the third search space set comprises at least a search space set index and an index of an associated CORESET in the configuration information of the one search space set.

In one embodiment, the configuration information of the third search space set comprises at least a search space set index, an index of an associated CORESET and an indication of a link to another search space set in the configuration information of the one search space set.

In one embodiment, an indication of a link to another search space set in the configuration information of the one search space set includes a searchSpaceLinkingId field.

In one embodiment, an indication of a link to another search space set in the configuration information of the one search space set is a searchSpaceLinkingId field.

In one embodiment, an indication of a link to another search space set in the configuration information of the one search space set is carried by a searchSpaceLinkingId field.

Typically, the first search space set and the second search space set are linked, and the first search space set and the third search space set are linked.

In one embodiment, “the first search space set and the second search space set are linked” comprises: configuration information of the first search space set comprising at least one first-type parameter, and configuration information of the second search space set comprising at least one first-type parameter, where one first-type parameter in the configuration information of the first search space set and one first-type parameter in the configuration information of the second search space set have the same value.

In one subembodiment, the first-type parameter comprises an indication of a link to another search space set in the configuration information of the one search space set.

In one subembodiment, the first-type parameter comprises a searchSpaceLinkingId.

In one subembodiment, the first-type parameter is a searchSpaceLinkingId.

In one subembodiment, the value of the first-type parameter is an integer.

In one subembodiment, the value of the first-type parameter is a non-negative integer.

In one embodiment, “the first search space set and the second search space set are linked” comprises: one PDCCH candidate in the first search space set and one PDCCH candidate in the second search space set being monitored to detect a DCI format with identical information.

In one embodiment, “the first search space set and the second search space set are linked” comprises: M PDCCH candidates in the first search space set corresponding to M PDCCH candidates in the second search space set, respectively, and any one of the M PDCCH candidates in the first search space set and a corresponding PDCCH candidate in the second search space set being monitored to detect a DCI format with identical information.

In one embodiment, M is an integer.

In one embodiment, M is a positive integer.

In one embodiment, “one PDCCH candidate in the first search space set corresponds to one PDCCH candidate in the second search space set” means: an index of the one PDCCH candidate in the first search space set being the same as an index of the one PDCCH candidate in the second search space set.

In one embodiment, “one PDCCH candidate in the first search space set corresponds to one PDCCH candidate in the second search space set” means: the one PDCCH candidate in the first search space set and the one PDCCH candidate in the second search space set belonging to the same slot.

In one embodiment, “one PDCCH candidate in the first search space set corresponds to one PDCCH candidate in the second search space set” means: an index of the one PDCCH candidate in the first search space set being the same as an index of the one PDCCH candidate in the second search space set and the one PDCCH candidate in the first search space set belonging to the same slot as the one PDCCH candidate in the second search space set.

In one embodiment, “one PDCCH candidate in the first search space set corresponds to one PDCCH candidate in the second search space set” means that within a first time span, an index of a PDCCH monitoring occasion in the first search space set is the same as an index of a PDCCH monitoring occasion in the second search space set, and an index of a PDCCH candidate in the PDCCH monitoring occasion in the first search space set is the same as an index of a PDCCH candidate in the PDCCH monitoring occasion in the second search space set.

In one embodiment, the first time span comprises at least one PDCCH monitoring occasion.

In one embodiment, the first time span comprises at least one PDCCH monitoring occasion in the first search space set.

In one embodiment, the first time span comprises at least one PDCCH monitoring occasion in the second search space set.

In one embodiment, the first time span comprises at least one PDCCH monitoring occasion in the first search space set and at least one PDCCH monitoring occasion in the second search space set.

In one embodiment, the first time span comprises at least one slot.

In one embodiment, the first time span comprises one slot.

In one embodiment, the first time span is a slot.

In one embodiment, the first time span comprises at least one subframe.

In one embodiment, the first time span comprises one subframe.

In one embodiment, the first time span is a subframe.

In one embodiment, “one PDCCH candidate in the first search space set corresponds to one PDCCH candidate in the second search space set” means: an identifier of the one PDCCH candidate in the first search space set being the same as an identifier of the one PDCCH candidate in the second search space set.

In one embodiment, “one PDCCH candidate in the first search space set corresponds to one PDCCH candidate in the second search space set” means that within a first time span, an index of a PDCCH monitoring occasion in the first search space set is the same as an index of a PDCCH monitoring occasion in the second search space set, and an identifier of a PDCCH candidate in the PDCCH monitoring occasion in the first search space set is the same as an identifier of a PDCCH candidate in the PDCCH monitoring occasion in the second search space set.

In one embodiment, “the first search space set and the second search space set are linked” comprises: the first search space set and the second search space set having identical periodicity and offset for PDCCH monitoring, identical numbers of slots existing in the search space sets or identical numbers of slots in consecutive slot groups, identical numbers of PDCCH candidates per CCE aggregation level, and identical numbers of non-overlapping PDCCH monitoring occasions per slot.

In one embodiment, “the first search space set and the second search space set are linked” comprises: the first search space set and the second search space set having identical periodicity and offset for PDCCH monitoring, identical numbers of slots existing in the search space sets or identical numbers of slots in consecutive slot groups, identical numbers of PDCCH candidates per CCE aggregation level, and identical numbers of non-overlapping PDCCH monitoring occasions per slot, and one PDCCH candidate in the first search space set and one PDCCH candidate in the second search space set being monitored for the detection of a DCI format with identical information.

In one embodiment, “the first search space set and the second search space set are linked” comprises: the first search space set and the second search space set having identical periodicity and offset for PDCCH monitoring, identical numbers of slots existing in the search space sets or identical numbers of slots in consecutive slot groups, identical numbers of PDCCH candidates per CCE aggregation level, and M PDCCH candidates in the first search space set corresponding to M PDCCH candidates in the second search space set, respectively, and any one of the M PDCCH candidates in the first search space set and a corresponding PDCCH candidate in the second search space set being monitored for the detection of a DCI format with identical information.

In one embodiment, “the first search space set and the third search space set are linked” comprises: configuration information of the first search space set comprising at least one first-type parameter, and configuration information of the third search space set comprising at least one first-type parameter, where one first-type parameter in the configuration information of the first search space set and one first-type parameter in the configuration information of the third search space set have the same value.

In one subembodiment, the first-type parameter comprises an indication of a link to another search space set in the configuration information of the one search space set.

In one subembodiment, the first-type parameter comprises a searchSpaceLinkingId.

In one subembodiment, the first-type parameter is a searchSpaceLinkingId.

In one subembodiment, the value of the first-type parameter is an integer.

In one subembodiment, the value of the first-type parameter is a non-negative integer.

In one embodiment, “the first search space set and the third search space set are linked” comprises: one PDCCH candidate in the first search space set and one PDCCH candidate in the third search space set being monitored for the detection of a DCI format with identical information.

In one embodiment, “the first search space set and the third search space set are linked” comprises: M PDCCH candidates in the first search space set corresponding to M PDCCH candidates in the third search space set, respectively, and any one of the M PDCCH candidates in the first search space set and a corresponding PDCCH candidate in the third search space set being monitored for the detection of a DCI format with identical information.

In one embodiment, M is an integer.

In one embodiment, M is a positive integer.

In one embodiment, “one PDCCH candidate in the first search space set corresponds to one PDCCH candidate in the third search space set” means: an index of the one PDCCH candidate in the first search space set being the same as an index of the one PDCCH candidate in the third search space set.

In one embodiment, “one PDCCH candidate in the first search space set corresponds to one PDCCH candidate in the third search space set” means: the one PDCCH candidate in the first search space set and the one PDCCH candidate in the third search space set belonging to the same slot.

In one embodiment, “one PDCCH candidate in the first search space set corresponds to one PDCCH candidate in the third search space set” means: an index of the one PDCCH candidate in the first search space set being the same as an index of the one PDCCH candidate in the third search space set and the one PDCCH candidate in the first search space set belonging to the same slot as the one PDCCH candidate in the third search space set.

In one embodiment, “one PDCCH candidate in the first search space set corresponds to one PDCCH candidate in the third search space set” means that within a second time span, an index of a PDCCH monitoring occasion in the first search space set is the same as an index of a PDCCH monitoring occasion in the third search space set, and an index of a PDCCH candidate in the PDCCH monitoring occasion in the first search space set is the same as an index of a PDCCH candidate in the PDCCH monitoring occasion in the third search space set.

In one embodiment, the second time span comprises at least one PDCCH monitoring occasion.

In one embodiment, the second time span comprises at least one PDCCH monitoring occasion in the first search space set.

In one embodiment, the second time span comprises at least one PDCCH monitoring occasion in the third search space set.

In one embodiment, the second time span comprises at least one PDCCH monitoring occasion in the first search space set and at least one PDCCH monitoring occasion in the third search space set.

In one embodiment, the second time span comprises at least one slot.

In one embodiment, the second time span comprises one slot.

In one embodiment, the second time span is a slot.

In one embodiment, the second time span comprises at least one subframe.

In one embodiment, the second time span comprises one subframe.

In one embodiment, the second time span is a subframe.

In one embodiment, “one PDCCH candidate in the first search space set corresponds to one PDCCH candidate in the third search space set” means: an identifier of the one PDCCH candidate in the first search space set being the same as an identifier of the one PDCCH candidate in the third search space set.

In one embodiment, “one PDCCH candidate in the first search space set corresponds to one PDCCH candidate in the third search space set” means that within a second time span, an index of a PDCCH monitoring occasion in the first search space set is the same as an index of a PDCCH monitoring occasion in the third search space set, and an identifier of a PDCCH candidate in the PDCCH monitoring occasion in the first search space set is the same as an identifier of a PDCCH candidate in the PDCCH monitoring occasion in the third search space set.

In one embodiment, “the first search space set and the third search space set are linked” comprises: the first search space set and the third search space set having identical periodicity and offset for PDCCH monitoring, identical numbers of slots existing in the search space sets or identical numbers of slots in consecutive slot groups, identical numbers of PDCCH candidates per CCE aggregation level, and identical numbers of non-overlapping PDCCH monitoring occasions per slot.

In one embodiment, “the first search space set and the third search space set are linked” comprises: the first search space set and the third search space set having identical periodicity and offset for PDCCH monitoring, identical numbers of slots existing in the search space sets or identical numbers of slots in consecutive slot groups, identical numbers of PDCCH candidates per CCE aggregation level, and identical numbers of non-overlapping PDCCH monitoring occasions per slot, and one PDCCH candidate in the first search space set and one PDCCH candidate in the third search space set being monitored for the detection of a DCI format with identical information.

In one embodiment, “the first search space set and the third search space set are linked” comprises: the first search space set and the third search space set having identical periodicity and offset for PDCCH monitoring, identical numbers of slots existing in the search space sets or identical numbers of slots in consecutive slot groups, identical numbers of PDCCH candidates per CCE aggregation level, and M PDCCH candidates in the first search space set corresponding to M PDCCH candidates in the third search space set, respectively, and any one of the M PDCCH candidates in the first search space set and a corresponding PDCCH candidate in the third search space set being monitored for the detection of a DCI format with identical information.

In one embodiment, the second information block comprises configuration information of the first search space set, configuration information of the second search space set and configuration information of the third search space set; the configuration information of the first search space set includes one first-type parameter, the configuration information of the second search space set includes one first-type parameter, and the configuration information of the third search space set includes one first-type parameter, and the first-type parameter included in the configuration information of the first search space set has the same value as the first-type parameter in the configuration information of the second search space set and the first-type parameter in the configuration information of the third search space set.

In one embodiment, the first information block is carried by a higher layer signaling.

In one embodiment, the first information block is carried by a Radio Resource Control (RRC) signaling.

In one embodiment, the first information block comprises all or part of fields in an RRC Information Element (IE).

In one embodiment, the first information block comprises all or part of fields in each one of multiple RRC IEs.

In one embodiment, the first information block comprises all or part of fields in a TDD-UL-DL-ConfigCommon IE.

In one embodiment, the first information block comprises all or part of fields in a TDD-UL-DL-ConfigDedicated IE.

In one embodiment, the first information block comprises all or part of fields in a ServingCellConfig IE.

In one embodiment, the first information block comprises all or part of fields in a ServingCellConfigCommonSIB IE.

In one embodiment, the first information block comprises information in all or part of fields in a ServingCellConfigCommon IE.

In one embodiment, the first information block is carried by at least one RRC IE.

In one embodiment, the first information block is carried by a TDD-UL-DL-ConfigCommon IE.

In one embodiment, the first information block is carried by a TDD-UL-DL-ConfigDedicated IE.

In one embodiment, the first information block is carried by a ServingCellConfig IE.

In one embodiment, the first information block is carried by a ServingCellConfigCommonSIB IE.

In one embodiment, the first information block is carried by a ServingCellConfigCommon IE.

In one embodiment, a name of an IE carrying the first information block includes TDD-UL-DL-Config.

In one embodiment, a name of an IE carrying the first information block includes ServingCellConfig.

In one embodiment, the first information block is carried by a Medium Access Control layer Control Element (MAC CE).

In one embodiment, the first information block comprises a MAC CE.

In one embodiment, the first information block is carried by Downlink control information (DCI).

In one embodiment, the first information block comprises DCI.

In one embodiment, the first information block comprises one or more fields in a DCI.

In one embodiment, the first information block is carried by a DCI format 2_0.

In one embodiment, the first information block comprises a DCI format 2_0.

In one embodiment, the first information block is carried by an RRC signaling and a MAC CE together.

In one embodiment, the first information block is carried by a higher layer signaling and a DCI together.

In one embodiment, for the specific definitions of the TDD-UL-DL-ConfigCommon IE, the TDD-UL-DL-ConfigDedicated IE, the ServingCellConfig IE, the ServingCellConfigCommonSIB IE and the ServingCellConfigCommon IE, refer to Section 6.3.2 of 3GPP TS 38.331.

In one embodiment, for a specific definition of DCI format 2_0, refer to Section 7.3.1 of 3GPP TS 38.212.

In one embodiment, the first information block indicates the reference time-domain resource set.

In one embodiment, the first information block is used to indicate the reference time-domain resource set.

In one embodiment, the first information block explicitly indicates the reference time-domain resource set.

In one embodiment, the first information block implicitly indicates the reference time-domain resource set.

In one embodiment, the first information block indicates a periodicity and a time offset of the reference time-domain resource set.

In one embodiment, the first information block indicates time-domain resources included in the reference time-domain resource set within a period.

In one embodiment, the first information block indicates symbols included in the reference time-domain resource set within a period.

In one embodiment, the first information block indicates slots included in the reference time-domain resource set within a period.

In one embodiment, the first information block indicates which symbols belong to the reference time-domain resource set.

In one embodiment, the first information block configures the symbols in the reference time-domain resource set as a first type.

In one embodiment, the first information block indicates the reference time-domain resource set by configuring symbols in the reference time-domain resource set as a first type.

In one embodiment, the first type is different from Downlink (DL) and Uplink (UL).

In one embodiment, the first type is different from Uplink, Downlink and Flexible.

In one embodiment, the first type is different from sidelink.

In one embodiment, the first information block indicates the reference time-domain resource set by configuring frequency-domain resources for uplink for symbols configured as DL or Flexible by higher layer parameters.

In one embodiment, the higher layer parameter is an RRC parameter.

In one embodiment, the higher layer parameter includes tdd-UL-DL-ConfigurationCommon.

In one embodiment, the higher layer parameter includes tdd-UL-DL-ConfigurationDedicated.

In one embodiment, the higher layer parameter includes tdd-UL-DL-ConfigurationCommon and tdd-UL-DL-ConfigurationDedicated.

In one embodiment, the higher layer parameter includes at least one of tdd-UL-DL-ConfigurationCommon or tdd-UL-DL-ConfigurationDedicated.

In one embodiment, the reference time-domain resource set comprises one or more symbols.

In one embodiment, the reference time-domain resource set comprises one symbol.

In one embodiment, the reference time-domain resource set comprises multiple symbols.

In one embodiment, the reference time-domain resource set comprises one or more symbols of the first type.

In one embodiment, the reference time-domain resource set comprises at least one slot.

In one embodiment, the reference time-domain resource set comprises at least one subframe.

In one embodiment, the symbol is a single-carrier symbol.

In one embodiment, the symbol is a multi-carrier symbol.

In one embodiment, the multicarrier symbol is an Orthogonal Frequency Division Multiplexing (OFDM) Symbol.

In one embodiment, the multicarrier symbol is obtained by an output by transform precoding through OFDM Symbol Generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multi Carrier (FBMC) symbol.

In one embodiment, the multicarrier symbol comprises a Cyclic Prefix (CP).

In one embodiment, the reference time-domain resource set comprises symbols that are used for both uplink transmission and downlink transmission.

In one embodiment, any symbol in the reference time-domain resource set can be used for both uplink transmission and downlink transmission.

In one embodiment, any symbol in the reference time-domain resource set is used for both uplink transmission and downlink transmission.

In one embodiment, at least one symbol in the reference time-domain resource set is used for both uplink transmission and downlink transmission.

In one embodiment, at least one symbol in the reference time-domain resource set is configured both for uplink and for downlink.

In one embodiment, at least one symbol in the reference time-domain resource set is used both for uplink and for downlink.

In one embodiment, each symbol in the reference time-domain resource set is configured both for uplink and for downlink.

In one embodiment, each symbol in the reference time-domain resource set is used both for uplink and for downlink.

In one embodiment, at least one symbol in the reference time-domain resource set is configured for uplink in part of Resource Blocks (RBs) and for downlink in the other part of the RBs.

In one embodiment, at least one symbol in the reference time-domain resource set is used for uplink in part of RBs and for downlink in the other part of the RBs.

In one embodiment, each symbol in the reference time-domain resource set is configured for uplink in part of RBs and for downlink in the other part of the RBs.

In one embodiment, each symbol in the reference time-domain resource set is used for uplink in part of RBs and for downlink in the other part of the RBs.

In one embodiment, at least one symbol in the reference time-domain resource set is configured for uplink in part of RBs in one serving cell and for downlink in the other part of the RBs in the serving cell.

In one embodiment, at least one symbol in the reference time-domain resource set is used for uplink in part of RBs in one serving cell and for downlink in the other part of the RBs in the serving cell.

In one embodiment, each symbol in the reference time-domain resource set is configured for uplink in part of RBs in one serving cell and for downlink in the other part of the RBs in the serving cell.

In one embodiment, each symbol in the reference time-domain resource set is used for uplink in part of RBs in one serving cell and for downlink in the other part of the RBs in the serving cell.

In one embodiment, the reference time-domain resource set is configured to a serving cell; on the serving cell, at least one subcarrier or at least one RB is used for uplink transmission in at least one symbol of the reference time-domain resource set being configured as DL by the higher layer parameter.

In one embodiment, the reference time-domain resource set is configured to at least one BandWidth Part (BWP); on the at least one BWP, at least one subcarrier or at least one RB is used for uplink transmission in at least one symbol of the reference time-domain resource set being configured as DL by the higher layer parameter.

In one embodiment, the reference time-domain resource set is configured to a BWP; on the BWP, at least one subcarrier or at least one RB is used for uplink transmission in at least one symbol of the reference time-domain resource set being configured as DL by the higher layer parameter.

In one embodiment, the reference time-domain resource set is configured to a pair of DL BWP and UL BWP, and on the UL BWP of the pair of DL BWP and UL BWP, at least one subcarrier or at least one RB is used for uplink transmission in at least one symbol of the reference time-domain resource set being configured as DL by the higher layer parameter.

In one embodiment, the reference time-domain resource set is configured to a DL BWP; a first UL BWP is the UL BWP of a pair of DL BWP and UL BWP to which the DL BWP belongs; and on the first UL BWP, at least one subcarrier or at least one RB is used for uplink transmission in at least one symbol of the reference time-domain resource set being configured as DL by the higher layer parameter.

In one embodiment, the reference time-domain resource set is configured to a serving cell; on the serving cell, at least one subcarrier or at least one RB is used for uplink transmission in each symbol of the reference time-domain resource set being configured as DL by the higher layer parameter.

In one embodiment, the reference time-domain resource set is configured to at least one BandWidth Part (BWP); on the at least one BWP, at least one subcarrier or at least one RB is used for uplink transmission in each symbol of the reference time-domain resource set being configured as DL by the higher layer parameter.

In one embodiment, the reference time-domain resource set is configured to a BWP; on the BWP, at least one subcarrier or at least one RB is used for uplink transmission in each symbol of the reference time-domain resource set being configured as DL by the higher layer parameter.

In one embodiment, the reference time-domain resource set is configured to a pair of DL BWP and UL BWP, and on the UL BWP of the pair of DL BWP and UL BWP, at least one subcarrier or at least one RB is used for uplink transmission in each symbol of the reference time-domain resource set being configured as DL by the higher layer parameter.

In one embodiment, the reference time-domain resource set is configured to a DL BWP; a first UL BWP is the UL BWP of a pair of DL BWP and UL BWP to which the DL BWP belongs; and on the first UL BWP, at least one subcarrier or at least one RB is used for uplink transmission in each symbol of the reference time-domain resource set being configured as DL by the higher layer parameter.

In one embodiment, the RB comprises a positive integer number of subcarrier(s).

In one embodiment, the RB comprises a positive integer number of consecutive subcarriers.

In one embodiment, the RB comprises 12 consecutive subcarriers.

In one embodiment, the specific definition of the RB can be found in 3GPP TS 38.211, Section 4.

In one embodiment, the serving cell is a cell in which the first information block is transmitted.

In one embodiment, the serving cell is a cell in which the first information block is configured.

In one embodiment, the serving cell is a cell in which the first information block is included.

In one embodiment, the serving cell is a cell in which the second information block is transmitted.

In one embodiment, the serving cell is a cell in which the second information block is configured.

In one embodiment, the serving cell is a cell in which the second information block is included.

In one embodiment, the reference time-domain resource set includes symbols being used for full duplex/SBFD.

In one embodiment, each symbol in the reference time-domain resource set is used for full duplex/SBFD.

In one embodiment, the problem to be solved by the present application comprises: how to determine the linked search space sets in a system supporting full duplex/SBFD or in a system supporting uplink and downlink transmissions in the same symbol. In the method described above, the first search space set is linked to two search space sets, the target search space set being one of the two search space sets, and which of the two is the target search space set is dependent on whether the first time unit and the reference time-domain resource are orthogonal, hence the solution to the problem.

In one embodiment, an advantage of the above method includes: providing a more appropriate target search space set in symbols of different duplex types, improving the performance of monitoring the PDCCH candidates.

In one embodiment, any symbol not belonging to the reference time-domain resource set is used only for uplink or only for downlink.

In one embodiment, any symbol not belonging to the reference time-domain resource set is configured only for uplink or only for downlink.

In one embodiment, any symbol not belonging to the reference time-domain resource set is used for uplink only or for downlink only in the serving cell.

In one embodiment, any symbol not belonging to the reference time-domain resource set is configured for uplink only or for downlink only in the serving cell.

In one embodiment, the first time unit comprises one or more symbols.

In one embodiment, the first time unit comprises one or more consecutive symbols.

In one embodiment, the first time unit comprises one or more slots.

In one embodiment, the first time unit comprises one or more PDCCH monitoring occasions of the first search space set, one or more PDCCH monitoring occasions of the second search space set and one or more PDCCH monitoring occasions of the third search space set.

In one embodiment, the first time unit comprises one PDCCH monitoring occasion of the first search space set, one PDCCH monitoring occasion of the second search space set and one PDCCH monitoring occasion of the third search space set.

In one embodiment, the first time unit comprises one or more PDCCH monitoring occasions of the first search space set and one or more PDCCH monitoring occasions of the target search space set.

In one embodiment, the first time unit comprises one PDCCH monitoring occasion of the first search space set and one PDCCH monitoring occasion of the target search space set.

In one embodiment, the first time unit comprises one PDCCH monitoring occasion of the first search space set and one PDCCH monitoring occasion of the target search space set in the same slot.

In one embodiment, the first time unit comprises one PDCCH monitoring occasion of the first search space set and one PDCCH monitoring occasion of the target search space set, and one PDCCH candidate in the one PDCCH monitoring occasion of the first search space set and one PDCCH candidate in the one PDCCH monitoring occasion of the target search space set are monitored to detect a DCI format with identical information.

In one embodiment, the first time unit comprises one PDCCH monitoring occasion of the first search space set and one PDCCH monitoring occasion of the target search space set in a same slot; in the first time unit, N PDCCH candidates in the first search space set correspond to N PDCCH candidates in the target search space set, respectively; any of the N PDCCH candidates in the first search space set and a corresponding PDCCH candidate in the target search space set are monitored to detect a DCI format with identical information.

In one embodiment, N is an integer.

In one embodiment, N is a positive integer.

In one embodiment, the first time unit comprises one slot.

In one embodiment, the first time unit is a slot.

In one embodiment, the first node monitors at least one PDCCH candidate in the first search space set and at least one PDCCH candidate in the target search space set.

In one embodiment, the first node monitors at least the first PDCCH candidate in the first search space set and at least the target PDCCH candidate in the target search space set.

In one embodiment, the first node monitors multiple PDCCH candidates in the first search space set and multiple PDCCH candidates in the target search space set.

In one embodiment, the first node further monitors PDCCH candidate(s) in a search space set other than the first search space set and the target search space set.

In one embodiment, the first node further monitors one or more PDCCH candidates in a search space set other than the first search space set and the target search space set.

In one embodiment, the meaning of the “monitoring” includes receiving.

In one embodiment, the meaning of the “monitoring” includes performing decoding of a PDCCH candidate.

In one embodiment, the meaning of the “monitoring” includes performing Blind Decoding of a PDCCH candidate.

In one embodiment, the meaning of the “monitoring” includes performing decoding and Cyclic Redundancy Check (CRC) of a PDCCH candidate.

In one embodiment, the meaning of the “monitoring” includes performing decoding and Radio Network Temporary Identity (RNTI)-scrambled CRC checking of a PDCCH candidate.

In one embodiment, the meaning of the “monitoring” includes performing decoding of a PDCCH candidate based on DCI Format(s) being monitored.

In one embodiment, the meaning of the “monitoring” includes performing decoding of a PDCCH candidate based on one or more DCI Format(s) being monitored.

In one embodiment, the target PDCCH candidate and the first PDCCH candidate are included by a single PDCCH reception.

In one embodiment, the target PDCCH candidate and the first PDCCH candidate belong to a same PDCCH reception.

In one embodiment, the target PDCCH candidate is a PDCCH candidate in the target search space set being linked to the first PDCCH candidate.

In one embodiment, the target PDCCH candidate and the first PDCCH candidate are monitored to detect a DCI format with identical information.

In one embodiment, the target PDCCH candidate has the same index in the target search space set as the first PDCCH candidate has in the first search space set.

In one embodiment, the target PDCCH candidate and the first PDCCH candidate belong to a same slot in the time domain.

In one embodiment, the target PDCCH candidate and the first PDCCH candidate belong to a same slot in the time domain and an index of a PDCCH monitoring occasion in which the first PDCCH candidate is present is the same as an index of a PDCCH monitoring occasion in which the second PDCCH candidate is present.

In one embodiment, the second PDCCH candidate has the same index in the second search space set as the first PDCCH candidate has in the first search space set, the second PDCCH candidate and the first PDCCH candidate belong to a same slot in the time domain and an index of a PDCCH monitoring occasion in which the first PDCCH candidate is present is the same as an index of a PDCCH monitoring occasion in which the second PDCCH candidate is present.

In one embodiment, the first PDCCH candidate and the target PDCCH candidate include at least one identical symbol in the time domain.

In one embodiment, the first PDCCH candidate and the target PDCCH candidate are orthogonal in the time domain.

In one embodiment, the first PDCCH candidate and the target PDCCH candidate are overlapped in the time domain.

In one embodiment, “the first PDCCH candidate and the target PDCCH candidate are monitored to detect a DCI format with identical information” comprises: a DCI format that the first PDCCH candidate is monitored to detect and a DCI format that the target PDCCH candidate is monitored to detect having the same information.

In one embodiment, “the first PDCCH candidate and the target PDCCH candidate are monitored to detect a DCI format with identical information” comprises: the first PDCCH candidate and the target PDCCH candidate being monitored by the first node to detect DCI format having the same information.

In one embodiment, “the first PDCCH candidate and the target PDCCH candidate are monitored to detect a DCI format with identical information” comprises: monitoring for the first PDCCH candidate and the target PDCCH candidate being assumed by the first node to be used for the detection of DCI format having the same information.

In one embodiment, “the first PDCCH candidate and the target PDCCH candidate are monitored to detect a DCI format with identical information” comprises: the first PDCCH candidate and the target PDCCH candidate being monitored by the first node, the first node assuming that a DCI format that the first PDCCH candidate is monitored to detect and a DCI format that the target PDCCH candidate is monitored to detect have the same information.

In one embodiment, the target search space set is the second search space set.

In one embodiment, the target search space set is the third search space set.

In one embodiment, whether the target search space set is the second search space set or the third search space set is dependent on whether the first time unit and the reference time-domain resource set are orthogonal.

In one embodiment, whether the target search space set is the second search space set or the third search space set is dependent on whether a PDCCH monitoring occasion in which the at least first PDCCH candidate in the first search space set being monitored in the first time unit is present is orthogonal to the reference time-domain resource set.

In one embodiment, whether the target search space set is the second search space set or the third search space set is dependent on whether a PDCCH monitoring occasion of the second search space set in the first time unit is orthogonal to the reference time-domain resource set.

In one embodiment, whether the target search space set is the second search space set or the third search space set is dependent on whether a PDCCH monitoring occasion in which the at least first PDCCH candidate in the first search space set being monitored in the first time unit is present and a PDCCH monitoring occasion of the second search space set in the first time unit are orthogonal to the reference time-domain resource set.

In one embodiment, whether the target search space set is the second search space set or the third search space set is dependent on whether a PDCCH monitoring occasion in which the at least first PDCCH candidate in the first search space set being monitored in the first time unit is present is orthogonal to the reference time-domain resource set and whether a PDCCH monitoring occasion of the second search space set in the first time unit is orthogonal to the reference time-domain resource set.

In one embodiment, when the first time unit is orthogonal to the reference time-domain resource set, the target search space set is the second search space set.

In one embodiment, when a PDCCH monitoring occasion in which the at least first PDCCH candidate in the first search space set is monitored in the first time unit is orthogonal to the reference time-domain resource set, the target search space set is the second search space set.

In one embodiment, when a PDCCH monitoring occasion of the second search space set in the first time unit is orthogonal to the reference time-domain resource set, the target search space set is the second search space set.

In one embodiment, when a PDCCH monitoring occasion in which the at least first PDCCH candidate in the first search space set is monitored in the first time unit and a PDCCH monitoring occasion of the second search space set in the first time unit are both orthogonal to the reference time-domain resource set, the target search space set is the second search space set.

In one embodiment, when a PDCCH monitoring occasion in which the at least first PDCCH candidate in the first search space set is monitored in the first time unit is orthogonal to the reference time-domain resource set and a PDCCH monitoring occasion of the second search space set in the first time unit is orthogonal to the reference time-domain resource set, the target search space set is the second search space set.

In one embodiment, when the first time unit overlaps with the reference time-domain resource set, the target search space set is the third search space set.

In one embodiment, when PDCCH monitoring occasion(s) of the second search space set in the first time unit belongs/belong to the reference time-domain resource set, the target search space set is the third search space set.

In one embodiment, when a PDCCH monitoring occasion in which the at least first PDCCH candidate in the first search space set is monitored in the first time unit belongs to the reference time-domain resource set, the target search space set is the third search space set.

In one embodiment, when PDCCH monitoring occasion(s) of the second search space set in the first time unit belongs/belong to the reference time-domain resource set and a PDCCH monitoring occasion in which the at least first PDCCH candidate in the first search space set being monitored in the first time unit is present belongs to the reference time-domain resource set, the target search space set is the third search space set.

In one embodiment, “the first time unit overlaps with the reference time-domain resource set” means that there is at least one symbol in the first time unit being overlapping with the reference time-domain resource set.

In one embodiment, “the first time unit overlaps with the reference time-domain resource set” means that there is at least one symbol in the first time unit belonging to the reference time-domain resource set.

In one embodiment, “the first time unit overlaps with the reference time-domain resource set” means that multiple symbols in the first time unit are overlapping with the reference time-domain resource set.

In one embodiment, “the first time unit overlaps with the reference time-domain resource set” means that multiple symbols in the first time unit belong to the reference time-domain resource set.

In one embodiment, “the first time unit overlaps with the reference time-domain resource set” means that a portion of the first time unit is overlapping with the reference time-domain resource set.

In one embodiment, “the first time unit overlaps with the reference time-domain resource set” means that the first time unit belongs to the reference time-domain resource set.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The network architecture 200 of the LTE, LTE-A and future 5G systems may be called an Evolved Packet System (EPS) 200. The 5G NR or LTE network architecture 200 may be called a 5G System/Evolved Packet System (5GS/EPS) 200 or other suitable terminology. The 5GS/EPS 200 may comprise one or more UEs 201, a UE 241 in sidelink communication with the UE(s) 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 includes NR (New Radio) Node B (gNB) 203 and other gNB 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the second node in the present application includes the gNB 203.

In one embodiment, a radio link between the UE 201 and the gNB 203 includes a cellular link.

In one embodiment, a transmitter of the first information block includes the gNB 203.

In one embodiment, a receiver of the first information block includes the UE 201.

In one embodiment, a transmitter of the second information block includes the gNB 203.

In one embodiment, a receiver of the second information block includes the UE 201.

In one embodiment, the gNB 203 supports SBFD.

In one embodiment, the gNB 203 supports a more flexible duplex mode or full duplex mode.

In one embodiment, the UE 201 supports SBFD.

In one embodiment, the UE 201 supports a more flexible duplex mode or full duplex mode.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs various signal processing functions of PHY layers. The L1 is called PHY 301 in the present application. The layer 2 (L2) 305 is above the PHY 301, and is in charge of the link between a first communication node and a second communication node as well as between two UEs. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the higher layer in the present application refers to a layer above the PHY layer.

In one embodiment, the first information block is generated by the RRC sublayer 306.

In one embodiment, the first information block is generated by the MAC sublayer 302 or the MAC sublayer 352.

In one embodiment, the first information block is generated by the PHY 301 or the PHY 351.

In one embodiment, the second information block is generated by the RRC sublayer 306.

In one embodiment, the second information block is generated by the MAC sublayer 302 or the MAC sublayer 352.

In one embodiment, the third information block is generated by the RRC sublayer 306.

In one embodiment, the third information block is generated by the MAC sublayer 302 or the MAC sublayer 352.

### Embodiment 4

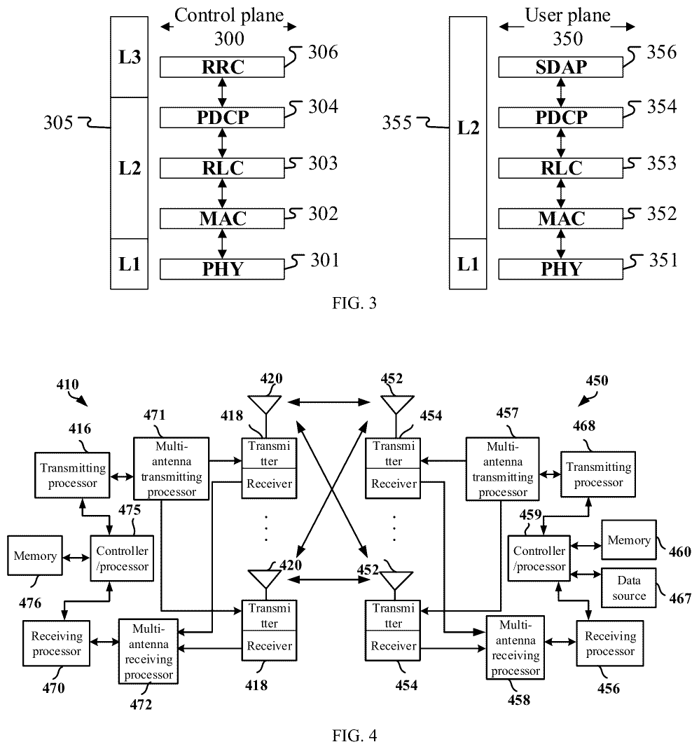

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In DownLink (DL) transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a second information block, the second information block being used to determine that a first search space set is linked to a second search space set and a third search space set; and receives a first information block, the first information block being used to determine a reference time-domain resource set; and monitors in a first time unit at least first PDCCH candidate in the first search space set and at least target PDCCH candidate in a target search space set; herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the second communication device 450 comprises a memory that stores a computer readable instruction program. The computer readable instruction program generates actions when executed by at least one processor. The actions include: receiving a second information block, the second information block being used to determine that a first search space set is linked to a second search space set and a third search space set; and receiving a first information block, the first information block being used to determine a reference time-domain resource set; and monitoring in a first time unit at least first PDCCH candidate in the first search space set and at least target PDCCH candidate in a target search space set; herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a second information block, the second information block being used to determine that a first search space set is linked to a second search space set and a third search space set; and transmits a first information block, the first information block being used to determine a reference time-domain resource set; herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the first communication device 410 comprises a memory that stores a computer readable instruction program. The computer readable instruction program generates actions when executed by at least one processor. The actions include: transmitting a second information block, the second information block being used to determine that a first search space set is linked to a second search space set and a third search space set; and transmitting a first information block, the first information block being used to determine a reference time-domain resource set; herein, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive the first information block in the present application; at least one of the antenna 420, the transmitter 418, the transmitting processor 416, the multi-antenna transmitting processor 471, the controller/processor 475 or the memory 476 is used to transmit the first information block in the present application.

In one embodiment, at least one of the antenna 452, the receiver 454, the receiving processor 456, the multi-antenna receiving processor 458, the controller/processor 459, the memory 460 or the data source 467 is used to receive the second information block in the present application; at least one of the antenna 420, the transmitter 418, the transmitting processor 416, the multi-antenna transmitting processor 471, the controller/processor 475 or the memory 476 is used to transmit the second information block in the present application.

In one embodiment, at least one of the antenna 452, the receiver 454, the receiving processor 456, the multi-antenna receiving processor 458, the controller/processor 459, the memory 460 or the data source 467 is used to receive the third information block in the present application; at least one of the antenna 420, the transmitter 418, the transmitting processor 416, the multi-antenna transmitting processor 471, the controller/processor 475 or the memory 476 is used to transmit the third information block in the present application.

### Embodiment 5

Embodiment 5 illustrates a flowchart of transmission according to one embodiment of the present application, as shown in FIG. 5. In FIG. 5, a first node U01 and a second node N02 are respectively two communication nodes that transmit via an air interface, where steps in the box F51 are optional.

The first node U01 receives a second information block in step S5101; receives a first information block in step S5102; receives a third information block in step S5103; and in step S5104, monitors in a first time unit at least first PDCCH candidate in the first search space set and at least target PDCCH candidate in a target search space set.

The second node N02 transmits a second information block in step S5201; transmits a first information block in step S5202; and transmits a third information block in step S5203.

In Embodiment 5, the second information block is used to determine that a first search space set is linked to a second search space set and a third search space set; the first information block is used to determine a reference time-domain resource set; the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, the first node U01 is the first node in the present application.

In one embodiment, the second node N02 is the second node in the present application.

In one embodiment, an air interface between the second node N02 and the first node U01 includes a radio interface between a base station and a UE.

In one embodiment, an air interface between the second node N02 and the first node U01 includes a radio interface between a relay node and a UE.

In one embodiment, an air interface between the second node N02 and the first node U01 includes a radio interface between a UE and another UE.

In one embodiment, the second node N02 is a maintenance base station for a serving cell of the first node U01.

In one embodiment, the second information block is used by the first node U01 to determine that a first search space set is linked to a second search space set and a third search space set.

In one embodiment, the first information block is used by the first node U01 to determine the reference time-domain resource set.

In one embodiment, steps marked by the dotted-line box F51 do not exist.

In one embodiment, steps marked by the dotted-line box F51 exist.

In one embodiment, the steps in dashed-line box F51 exist where the method in the first node U01 used for wireless communications comprises: receiving a third information block; where the third information block indicates configuration information of a first CORESET; where the first CORESET is associated with the first search space set, the configuration information of the first CORESET comprising two TCI states.

In one embodiment, the steps in dashed-line box F51 exist where the method in the second node N02 used for wireless communications comprises: transmitting a third information block; where the third information block indicates configuration information of a first CORESET; where the first CORESET is associated with the first search space set, the configuration information of the first CORESET comprising two TCI states.

In one embodiment, the third information block and the second information block belong to a same RRC IE.

In one embodiment, the third information block and the second information block belong to a same RRC IE whose name includes “PDCCH-Config”.

In one embodiment, the third information block and the second information block belong to a same IE PDCCH-Config.

In one embodiment, the third information block and the second information block belong to two RRC IEs respectively.

In one embodiment, the third information block and the second information block are received simultaneously.

In one embodiment, the third information block and the second information block are received together.

In one embodiment, reception of the third information block is not later than reception of the second information block.

In one embodiment, reception of the third information block is earlier than reception of the second information block.

In one embodiment, reception of the third information block is later than reception of the second information block.

In one embodiment, reception of the third information block is not earlier than reception of the second information block.

In one embodiment, reception of the first information block is not later than reception of the second information block.

In one embodiment, reception of the first information block is earlier than reception of the second information block.

In one embodiment, reception of the first information block is later than reception of the second information block.

In one embodiment, reception of the first information block is not earlier than reception of the second information block.

In one embodiment, the first information block and the second information block belong to a same RRC signaling.

In one embodiment, the first information block and the second information block are received together.

In one embodiment, the first information block is transmitted in a Physical Downlink Shared Channel (PDSCH).

In one embodiment, the first information block is transmitted in a Physical Downlink Control Channel (PDCCH).

In one embodiment, the second information block is transmitted in a PDSCH.

In one embodiment, the third information block is transmitted in a PDSCH.

In one embodiment, the second information block and the third information block are transmitted in a same PDSCH.

In one embodiment, the second information block and the third information block are transmitted in different PDSCHs.

### Embodiments 6A-6C

Embodiments 6A-6C each illustrate a schematic diagram of a target search space set being a third search space set according to one embodiment of the present application, as shown in FIG. 6A-FIG. 6C.

In Embodiment 6A, when the first time unit belongs to the reference time-domain resource set, the target search space set is the third search space set.

In Embodiment 6B, when PDCCH monitoring occasion(s) of the second search space set in the first time unit belongs/belong to the reference time-domain resource set, the target search space set is the third search space set.

In Embodiment 6C, when a PDCCH monitoring occasion in which the at least first PDCCH candidate in the first search space set is monitored in the first time unit belongs to the reference time-domain resource set, the target search space set is the third search space set.

In one embodiment, the first time unit comprises one PDCCH monitoring occasion of the first search space set, one PDCCH monitoring occasion of the second search space set and one PDCCH monitoring occasion of the third search space set.

In one embodiment, the first time unit is orthogonal to the reference time-domain resource set or the first time unit belongs to the reference time-domain resource set; when the first time unit is orthogonal to the reference time-domain resource set, the target search space set is the second search space set; when the first time unit belongs to the reference time-domain resource set, the target search space set is the third search space set.

In one embodiment, the first time unit is orthogonal to the reference time-domain resource set or the first time unit overlaps with the reference time-domain resource set; when the first time unit is orthogonal to the reference time-domain resource set, the target search space set is the second search space set; when the first time unit belongs to the reference time-domain resource set, the target search space set is the third search space set.

In one subembodiment, when partial symbols in the first time unit belong to the reference time-domain resource set, the target search space set is the third search space set.

In one subembodiment, when partial symbols in the first time unit belong to the reference time-domain resource set, the target search space set is the second search space set.

In one subembodiment, when a PDCCH monitoring occasion of the second search space set in the first time unit overlaps with the reference time-domain resource set, the target search space set is the third search space set.

In one subembodiment, when a PDCCH monitoring occasion of the second search space set in the first time unit belongs to the reference time-domain resource set, the target search space set is the third search space set.

In one subembodiment, when a PDCCH monitoring occasion in which the at least first PDCCH candidate in the first search space set is monitored in the first time unit overlaps with the reference time-domain resource set, the target search space set is the third search space set.

In one subembodiment, when a PDCCH monitoring occasion in which the at least first PDCCH candidate in the first search space set is monitored in the first time unit belongs to the reference time-domain resource set, the target search space set is the third search space set.

In one embodiment, the first time unit is orthogonal to the reference time-domain resource set or the first time unit overlaps with the reference time-domain resource set; when the first time unit is orthogonal to the reference time-domain resource set, the target search space set is the second search space set; when the first time unit overlaps with the reference time-domain resource set, the target search space set is the third search space set.

In one subembodiment, when the first time unit belongs to the reference time-domain resource set, the target search space set is the third search space set.

In one subembodiment, when a PDCCH monitoring occasion of the second search space set in the first time unit overlaps with the reference time-domain resource set, the target search space set is the third search space set.

In one subembodiment, when a PDCCH monitoring occasion in which the at least first PDCCH candidate in the first search space set is monitored in the first time unit overlaps with the reference time-domain resource set, the target search space set is the third search space set.

In one subembodiment, when a PDCCH monitoring occasion of the second search space set in the first time unit overlaps with the reference time-domain resource set and a PDCCH monitoring occasion in which the at least first PDCCH candidate in the first search space set being monitored in the first time unit is present overlaps with the reference time-domain resource set, the target search space set is the third search space set.

In one embodiment, the first time unit is orthogonal to the reference time-domain resource set or the first time unit overlaps with the reference time-domain resource set; when the first time unit is orthogonal to the reference time-domain resource set, the target search space set is the second search space set; when the first time unit overlaps with the reference time-domain resource set, the target search space set is the second search space set.

In one subembodiment, when the first time unit overlaps with the reference time-domain resource set, and a PDCCH monitoring occasion of the second search space set in the first time unit is orthogonal to the reference time-domain resource set, the target search space set is the second search space set.

In one subembodiment, when the first time unit overlaps with the reference time-domain resource set, and a PDCCH monitoring occasion in which the at least first PDCCH candidate in the first search space set being monitored in the first time unit is present is orthogonal to the reference time-domain resource set, the target search space set is the second search space set.

In one subembodiment, when the first time unit overlaps with the reference time-domain resource set, a PDCCH monitoring occasion of the second search space set in the first time unit is orthogonal to the reference time-domain resource set and a PDCCH monitoring occasion in which the at least first PDCCH candidate in the first search space set being monitored in the first time unit is present is orthogonal to the reference time-domain resource set, the target search space set is the second search space set.

### Embodiment 7

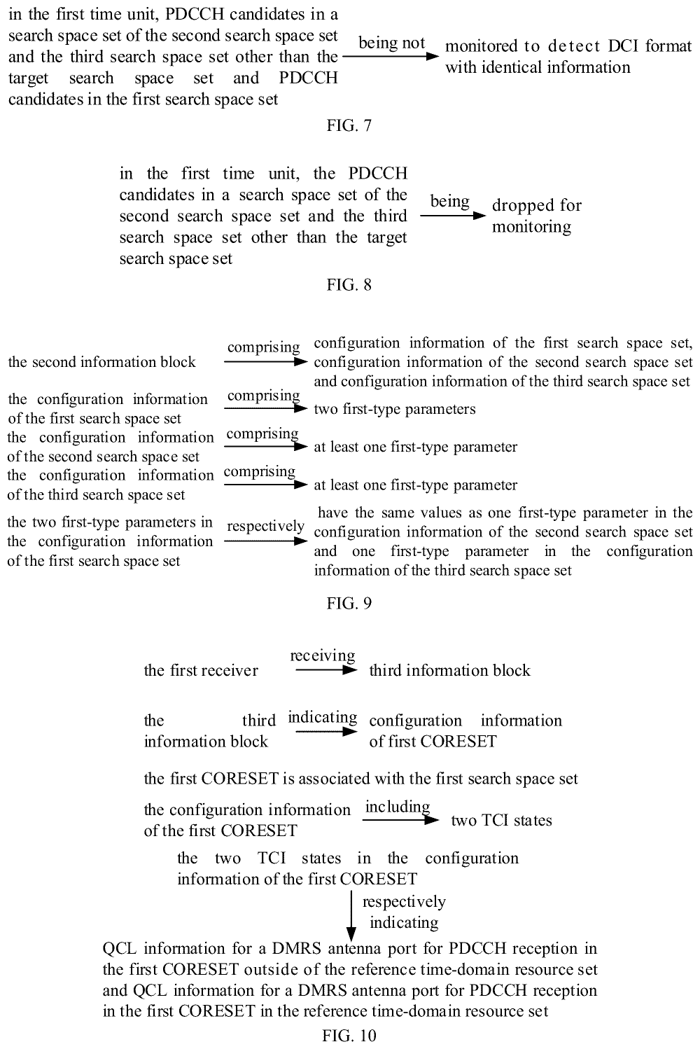

Embodiment 7 illustrates a schematic diagram of a PDCCH candidate not being monitored to detect a DCI format with identical information according to one embodiment of the present application; as shown in FIG. 7.

In Embodiment 7, in the first time unit, PDCCH candidates in a search space set of the second search space set and the third search space set other than the target search space set and PDCCH candidates in the first search space set are not monitored to detect a DCI format with identical information.

In one embodiment, in the first time unit, the other search space set of the second search space set and the third search space set other than the target search space set is the second search space set.

In one embodiment, in the first time unit, the other search space set of the second search space set and the third search space set other than the target search space set is the third search space set.

In one embodiment, in the first time unit, the target search space set is the third search space set, PDCCH candidates in the second search space set and PDCCH candidates in the first search space set being not monitored to detect a DCI format with identical information.

In one embodiment, in the first time unit, the target search space set is the second search space set, PDCCH candidates in the third search space set and PDCCH candidates in the first search space set being not monitored to detect a DCI format with identical information.

In one embodiment, “PDCCH candidates in the second search space set and PDCCH candidates in the first search space set being not monitored to detect a DCI format with identical information” comprises: the PDCCH candidates in the second search space set and the PDCCH candidates in the first search space set not being monitored by the first node for the detection of a DCI format with identical information.

In one embodiment, “PDCCH candidates in the second search space set and PDCCH candidates in the first search space set being not monitored to detect a DCI format with identical information” comprises: the PDCCH candidates in the second search space set and the PDCCH candidates in the first search space set being monitored by the first node, the monitoring for the PDCCH candidates in the second search space set and the PDCCH candidates in the first search space set not being used by the first node to detect a DCI format with identical information.

In one embodiment, “PDCCH candidates in the second search space set and PDCCH candidates in the first search space set being not monitored to detect a DCI format with identical information” comprises: the PDCCH candidates in the second search space set and the PDCCH candidates in the first search space set being monitored by the first node, the monitoring for the PDCCH candidates in the second search space set and the PDCCH candidates in the first search space set not being assumed by the first node to be used for detection of a DCI format with identical information.

In one embodiment, “PDCCH candidates in the second search space set and PDCCH candidates in the first search space set being not monitored to detect a DCI format with identical information” comprises: the PDCCH candidates in the second search space set and the PDCCH candidates in the first search space set being monitored by the first node, where the DCI format that the PDCCH candidates in the second search space set are monitored to detect and the DCI format that the PDCCH candidates in the first search space set are monitored to detect have different information.

In one embodiment, “PDCCH candidates in the second search space set and PDCCH candidates in the first search space set being not monitored to detect a DCI format with identical information” comprises: the PDCCH candidates in the second search space set and the PDCCH candidates in the first search space set being monitored by the first node, the first node assuming that the DCI format that the PDCCH candidates in the second search space set are monitored to detect and the DCI format that the PDCCH candidates in the first search space set are monitored to detect have different information.

In one embodiment, “PDCCH candidates in the second search space set and PDCCH candidates in the first search space set being not monitored to detect a DCI format with identical information” comprises: either one of the PDCCH candidates in the second search space set and the PDCCH candidates in the first search space set not being monitored by the first node.

In one embodiment, “PDCCH candidates in the second search space set and PDCCH candidates in the first search space set being not monitored to detect a DCI format with identical information” comprises: the PDCCH candidates in the second search space set not being monitored by the first node.

In one embodiment, “PDCCH candidates in the second search space set and PDCCH candidates in the first search space set being not monitored to detect a DCI format with identical information” comprises: whether the DCI format that the PDCCH candidates in the second search space set are monitored to detect and the DCI format that the PDCCH candidates in the first search space set are monitored to detect have identical information is related to implementation of the transmitter of the first information block.

In one embodiment, “PDCCH candidates in the second search space set and PDCCH candidates in the first search space set being not monitored to detect a DCI format with identical information” comprises: whether the DCI format that the PDCCH candidates in the second search space set are monitored to detect and the DCI format that the PDCCH candidates in the first search space set are monitored to detect have identical information is up to determination of the transmitter of the first information block.

In one embodiment, “PDCCH candidates in the third search space set and PDCCH candidates in the first search space set being not monitored to detect a DCI format with identical information” comprises: the PDCCH candidates in the third search space set and the PDCCH candidates in the first search space set not being monitored by the first node for the detection of a DCI format with identical information.

In one embodiment, “PDCCH candidates in the third search space set and PDCCH candidates in the first search space set being not monitored to detect a DCI format with identical information” comprises: the PDCCH candidates in the third search space set and the PDCCH candidates in the first search space set being monitored by the first node, the monitoring for the PDCCH candidates in the third search space set and the PDCCH candidates in the first search space set not being used by the first node to detect a DCI format with identical information.

In one embodiment, “PDCCH candidates in the third search space set and PDCCH candidates in the first search space set being not monitored to detect a DCI format with identical information” comprises: the PDCCH candidates in the third search space set and the PDCCH candidates in the first search space set being monitored by the first node, the monitoring for the PDCCH candidates in the third search space set and the PDCCH candidates in the first search space set not being assumed by the first node to be used for detection of a DCI format with identical information.

In one embodiment, “PDCCH candidates in the third search space set and PDCCH candidates in the first search space set being not monitored to detect a DCI format with identical information” comprises: the PDCCH candidates in the third search space set and the PDCCH candidates in the first search space set being monitored by the first node, where the DCI format that the PDCCH candidates in the third search space set are monitored to detect and the DCI format that the PDCCH candidates in the first search space set are monitored to detect have different information.

In one embodiment, “PDCCH candidates in the third search space set and PDCCH candidates in the first search space set being not monitored to detect a DCI format with identical information” comprises: the PDCCH candidates in the third search space set and the PDCCH candidates in the first search space set being monitored by the first node, the first node assuming that the DCI format that the PDCCH candidates in the third search space set are monitored to detect and the DCI format that the PDCCH candidates in the first search space set are monitored to detect have different information.

In one embodiment, “PDCCH candidates in the third search space set and PDCCH candidates in the first search space set being not monitored to detect a DCI format with identical information” comprises: either one of the PDCCH candidates in the third search space set and the PDCCH candidates in the first search space set not being monitored by the first node.

In one embodiment, “PDCCH candidates in the third search space set and PDCCH candidates in the first search space set being not monitored to detect a DCI format with identical information” comprises: the PDCCH candidates in the third search space set not being monitored by the first node.

In one embodiment, “PDCCH candidates in the third search space set and PDCCH candidates in the first search space set being not monitored to detect a DCI format with identical information” comprises: whether the DCI format that the PDCCH candidates in the third search space set are monitored to detect and the DCI format that the PDCCH candidates in the first search space set are monitored to detect have identical information is related to implementation of the transmitter of the first information block.

In one embodiment, “PDCCH candidates in the third search space set and PDCCH candidates in the first search space set being not monitored to detect a DCI format with identical information” comprises: whether the DCI format that the PDCCH candidates in the third search space set are monitored to detect and the DCI format that the PDCCH candidates in the first search space set are monitored to detect have identical information is up to decision of the transmitter of the first information block.

### Embodiment 8

Embodiment 8 illustrates a schematic diagram of monitoring of PDCCH candidate being dropped according to one embodiment of the present application, as shown in FIG. 8.

In Embodiment 8, in the first time unit, monitoring of the PDCCH candidates is dropped in a search space set of the second search space set and the third search space set other than the target search space set.

In one embodiment, in the first time unit, the target search space set is the third search space set, and monitoring of the PDCCH candidates in the second search space set is dropped.

In one embodiment, in the first time unit, the target search space set is the second search space set, and monitoring of the PDCCH candidates in the third search space set is dropped.

In one embodiment, “monitoring of the PDCCH candidates in the second search space set is dropped” comprises: the monitoring of the PDCCH candidates in the second search space set being dropped by the first node.

In one embodiment, “monitoring of the PDCCH candidates in the second search space set is dropped” comprises: the first node not monitoring the PDCCH candidates in the second search space set.

In one embodiment, “monitoring of the PDCCH candidates in the second search space set is dropped” comprises: the first node not being required to monitor the PDCCH candidates in the second search space set.

In one embodiment, “monitoring of the PDCCH candidates in the second search space set is dropped” comprises: whether the monitoring of the PDCCH candidates in the second search space set is dropped being related to implementation of the first node.

In one embodiment, “monitoring of the PDCCH candidates in the second search space set is dropped” comprises: whether the monitoring of the PDCCH candidates in the second search space set is dropped being up to decision of the first node.

In one embodiment, “monitoring of the PDCCH candidates in the third search space set is dropped” comprises: the monitoring of the PDCCH candidates in the third search space set being dropped by the first node.

In one embodiment, “monitoring of the PDCCH candidates in the third search space set is dropped” comprises: the first node not monitoring the PDCCH candidates in the third search space set.

In one embodiment, “monitoring of the PDCCH candidates in the third search space set is dropped” comprises: the first node not being required to monitor the PDCCH candidates in the third search space set.

In one embodiment, “monitoring of the PDCCH candidates in the third search space set is dropped” comprises: whether the monitoring of the PDCCH candidates in the third search space set is dropped being related to implementation of the first node.

In one embodiment, “monitoring of the PDCCH candidates in the third search space set is dropped” comprises: whether the monitoring of the PDCCH candidates in the third search space set is dropped being up to decision of the first node.

### Embodiment 9

Embodiment 9 illustrates a schematic diagram of a first-type parameter according to one embodiment of the present application, as shown in FIG. 9.

In Embodiment 9, the second information block comprises configuration information of the first search space set, configuration information of the second search space set and configuration information of the third search space set; the configuration information of the first search space set comprises two first-type parameters, the configuration information of the second search space set comprises at least one first-type parameter, and the configuration information of the third search space set comprises at least one first-type parameter, and the two first-type parameters comprised in the configuration information of the first search space set respectively have the same values as one first-type parameter in the configuration information of the second search space set and one first-type parameter in the configuration information of the third search space set.

In one embodiment, the first-type parameter is a searchSpaceLinkingId.

In one embodiment, a name of the first-type parameter includes searchSpaceLinkingId.

In one embodiment, a name of the first-type parameter includes searchSpaceLinking.

In one embodiment, the specific definition of the searchSpaceLinkingId can be found in 3GPP TS 38.213, Section 10.

In one embodiment, the configuration information of the first search space set comprises two first-type parameters, the two first-type parameters having different values.

In one embodiment, the configuration information of the first search space set comprises two first-type parameters, the two first-type parameters having identical values.

In one embodiment, the first search space set is a search space set.

In one embodiment, the second search space set is a search space set.

In one embodiment, the third search space set is a search space set.

In one embodiment, configuration information of a search space set comprises at least one of the first-type parameters.

In one embodiment, configuration information of a search space set comprises one or two of the first-type parameters.

In one embodiment, configuration information of a search space set comprises two of the first-type parameters.

In one embodiment, the number of the first-type parameters included in the configuration information of a search space set is used to determine the number of search space sets linked to the search space set.

In one embodiment, the number of the first-type parameters included in the configuration information of a search space set is equal to the number of search space sets linked to the search space set.

In one embodiment, the number of the first-type parameters included in the configuration information of a search space set is used to determine whether search space sets linked to the search space set in different slots are the same.

In one embodiment, when the configuration information of a search space set comprises only one of the first-type parameters, search space sets linked to the search space set respectively in two different slots are different.

In one embodiment, one first-type parameter of the two first-type parameters in the configuration information of the first search space set has the same value as one first-type parameter in the configuration information of the second search space set, and the other one first-type parameter of the two first-type parameters in the configuration information of the first search space set has the same value as one first-type parameter in the configuration information of the third search space set.

### Embodiment 10

Embodiment 10 illustrates a schematic diagram of a third information block according to one embodiment of the present application, as shown in FIG. 10.

In Embodiment 10, the first receiver receives a third information block; where the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside of the reference time-domain resource set and QCL information for a DMRS antenna port for PDCCH reception in the first CORESET in the reference time-domain resource set.

In one embodiment, the third information block also indicates configuration information of a second CORESET; the second CORESET is associated with the second search space set, and the configuration information of the second CORESET includes at least one TCI state; one TCI state in the configuration information of the second CORESET indicates QCL information for a DMRS antenna port for PDCCH reception in the second CORESET outside of the reference time-domain resource set.

In one embodiment, the third information block also indicates configuration information of a third CORESET; the third CORESET is associated with the third search space set, and the configuration information of the third CORESET includes at least one TCI state; one TCI state in the configuration information of the third CORESET indicates QCL information for a DMRS antenna port for PDCCH reception in the third CORESET outside of the reference time-domain resource set.

In one embodiment, the third information block is carried by a higher layer signaling.

In one embodiment, the third information block is carried by an RRC signaling.

In one embodiment, the third information block comprises information in all or part of fields in an RRC IE.

In one embodiment, the third information block comprises information in all or part of fields in each one of multiple RRC IEs.

In one embodiment, the third information block comprises information in all or part of fields in an RRC IE that includes “ControlResourceSet” in its name.

In one embodiment, the third information block comprises information in all or part of fields in an IE ControlResourceSet.

In one embodiment, the third information block comprises information in all or part of fields in each one of multiple IEs ControlResourceSet.

In one embodiment, the third information block comprises information in all or part of fields in each one of three IEs ControlResourceSet.

In one embodiment, the third information block comprises a field in an IE ControlResourceSete whose name includes “tci-StatesPDCCH”.

In one embodiment, the third information block comprises a field tci-StatesPDCCH-ToAddList in an IE ControlResourceSet.

In one embodiment, the third information block comprises a field whose name includes “tci-StatesPDCCH” in each one of multiple IEs ControlResourceSet.

In one embodiment, the third information block comprises a field tci-StatesPDCCH-ToAddList in each one of multiple IEs ControlResourceSet.

In one embodiment, the third information block comprises a field whose name includes “tci-StatesPDCCH” in each one of three IEs ControlResourceSet.

In one embodiment, the third information block comprises a field tci-StatesPDCCH-ToAddList in each one of three IEs ControlResourceSet.

In one embodiment, the third information block comprises three IEs ControlResourceSet, where information in a tci-StatesPDCCH-ToAddList field of the first of the three IEs ControlResourceSet includes two TCI states included in the configuration information of the first CORESET; where information in a tci-StatesPDCCH-ToAddList field of the second of the three IEs ControlResourceSet includes at least one TCI state included in the configuration information of the second CORESET; where information in a tci-StatesPDCCH-ToAddList field of the third of the three IEs ControlResourceSet includes at least one TCI state included in the configuration information of the third CORESET.

In one embodiment, the third information block comprises one or more RRC IEs.

In one embodiment, the third information block comprises one or more IEs ControlResourceSet.

In one embodiment, the third information block comprises multiple IEs ControlResourceSet.

In one embodiment, the third information block comprises three IEs ControlResourceSet.

In one embodiment, for specific definitions of the IE ControlResourceSet and tci-StatesPDCCH-ToAddList field, refer to Section 6.3.2 of 3GPP TS 38.331.

In one embodiment, the third information block indicates configuration information of the first CORESET.

In one embodiment, the third information block also indicates configuration information of the second CORESET and configuration information of the third CORESET.

In one embodiment, the third information block comprises three RRC IEs, the three RRC IEs respectively indicating configuration information of the first CORESET, configuration information of the second CORESET and configuration information of the third CORESET.

In one embodiment, the third information block comprises three IEs ControlResourceSet, the three IEs ControlResourceSet indicating configuration information of the first CORESET, configuration information of the second CORESET and configuration information of the third CORESET, respectively.

In one embodiment, the configuration information of a CORESET comprises: a CORESET index, a DMRS scrambling sequence initialization value, a frequency domain precoder granularity, a number of consecutive symbols for the CORESET, a frequency domain resource for the CORESET, CCE (i.e., Control Channel Element) to REG (i.e., Resource Element Group) mapping parameters, QCL information for DMRS antenna ports for the PDCCH reception, and an indication of the presence or absence of a TCI field for the DCI format.

In one embodiment, the configuration information of one CORESET is specified in Section 10.1 of 3GPP TS 38.213.

In one embodiment, a controlResourceSetId field in an IE ControlResourceSet included in the third information block indicates a CORESET index.

In one embodiment, a pdcch-DMRS-ScramblingID field in an IE ControlResourceSet included in the third information block indicates a DMRS scrambling sequence initialization value.

In one embodiment, a precoderGranularity field in an IE ControlResourceSet included in the third information block indicates a frequency domain precoder granularity.

In one embodiment, a duration field in an IE ControlResourceSet included in the third information block indicates the number of consecutive symbols of the CORESET.

In one embodiment, a frequencyDomainResources field in an IE ControlResourceSet included in the third information block indicates frequency domain resources of the CORESET.

In one embodiment, a cce-REG-MappingType field in an IE ControlResourceSet included in the third information block indicates a CCE to REG mapping parameter.

In one embodiment, a tci-StatesPDCCH-ToAddList field in an IE ControlResourceSet included in the third information block indicates QCL information for a DMRS antenna port for PDCCH reception.

In one embodiment, a tci-PresentInDCI field or tci-PresentDCI-1-2 field in an IE ControlResourceSet included in the third information block indicates an indication of the presence or absence of a TCI field for the DCI format.

In one embodiment, the configuration information of the first CORESET comprises part or all of the configuration information of the one CORESET.

In one embodiment, the configuration information of the first CORESET includes at least a CORESET index in the configuration information of the one CORESET.

In one embodiment, the configuration information of the first CORESET includes at least a CORESET index, a frequency domain precoder granularity, a number of consecutive symbols of the CORESET, and frequency domain resource of the CORESET in the configuration information of the one CORESET.

In one embodiment, the configuration information of the first CORESET comprises at least QCL information for a DMRS antenna port for PDCCH reception in the configuration information of the one CORESET.

In one embodiment, the configuration information of the first CORESET comprises at least a CORESET index and QCL information for a DMRS antenna port for PDCCH reception in the configuration information of the one CORESET.

In one embodiment, the configuration information of the first CORESET includes at least a CORESET index, a frequency domain precoder granularity, a number of consecutive symbols of the CORESET, frequency domain resource of the CORESET and QCL information for a DMRS antenna port for PDCCH reception in the configuration information of the one CORESET.

In one embodiment, the configuration information of the second CORESET comprises part or all of the configuration information of the one CORESET.

In one embodiment, the configuration information of the second CORESET includes at least a CORESET index in the configuration information of the one CORESET.

In one embodiment, the configuration information of the second CORESET includes at least a CORESET index, a frequency domain precoder granularity, a number of consecutive symbols of the CORESET, and frequency domain resource of the CORESET in the configuration information of the one CORESET.

In one embodiment, the configuration information of the second CORESET comprises at least QCL information for a DMRS antenna port for PDCCH reception in the configuration information of the one CORESET.

In one embodiment, the configuration information of the second CORESET comprises at least a CORESET index and QCL information for a DMRS antenna port for PDCCH reception in the configuration information of the one CORESET.

In one embodiment, the configuration information of the second CORESET includes at least a CORESET index, a frequency domain precoder granularity, a number of consecutive symbols of the CORESET, frequency domain resource of the CORESET and QCL information for a DMRS antenna port for PDCCH reception in the configuration information of the one CORESET.

In one embodiment, the configuration information of the third CORESET comprises part or all of the configuration information of the one CORESET.

In one embodiment, the configuration information of the third CORESET includes at least a CORESET index in the configuration information of the one CORESET.

In one embodiment, the configuration information of the third CORESET includes at least a CORESET index, a frequency domain precoder granularity, a number of consecutive symbols of the CORESET, and frequency domain resource of the CORESET in the configuration information of the one CORESET.

In one embodiment, the configuration information of the third CORESET comprises at least QCL information for a DMRS antenna port for PDCCH reception in the configuration information of the one CORESET.

In one embodiment, the configuration information of the third CORESET comprises at least a CORESET index and QCL information for a DMRS antenna port for PDCCH reception in the configuration information of the one CORESET.

In one embodiment, the configuration information of the third CORESET includes at least a CORESET index, a frequency domain precoder granularity, a number of consecutive symbols of the CORESET, frequency domain resource of the CORESET and QCL information for a DMRS antenna port for PDCCH reception in the configuration information of the one CORESET.

In one embodiment, “the first CORESET is associated with the first search space set” comprises: the configuration information of the first search space set including an index of the first CORESET.

In one embodiment, “the first CORESET is associated with the first search space set” comprises: the first search space set being a search space set configured with an index of the first CORESET.

In one embodiment, “the first CORESET is associated with the first search space set” comprises: the first CORESET being used to determine time-frequency resources occupied by one PDCCH monitoring occasion in the first search space set.

In one embodiment, “the first CORESET is associated with the first search space set” comprises: the first CORESET comprising time-frequency resources occupied by one PDCCH monitoring occasion in the first search space set.

In one embodiment, “the first CORESET is associated with the first search space set” comprises: Resource Elements (REs) occupied by the first CORESET including REs occupied by one PDCCH monitoring occasion in the first search space set.

In one embodiment, “the first CORESET is associated with the first search space set” comprises: RBs occupied by the first CORESET in frequency domain including RBs occupied by one PDCCH monitoring occasion in the first search space set.

In one embodiment, “the first CORESET is associated with the first search space set” comprises: frequency-domain resources occupied by the first CORESET including frequency-domain resources occupied by one PDCCH monitoring occasion in the first search space set.

In one embodiment, “the first CORESET is associated with the first search space set” comprises: symbols occupied by the first CORESET being used to determine symbols occupied by one PDCCH monitoring occasion in the first search space set.

In one embodiment, “the first CORESET is associated with the first search space set” comprises: symbols occupied by the first CORESET including symbols occupied by one PDCCH monitoring occasion in the first search space set.

In one embodiment, “the second CORESET is associated with the second search space set” comprises: the configuration information of the second search space set including an index of the second CORESET.

In one embodiment, “the second CORESET is associated with the second search space set” comprises: the second search space set being a search space set configured with an index of the second CORESET.

In one embodiment, “the second CORESET is associated with the second search space set” comprises: the second CORESET being used to determine time-frequency resources occupied by one PDCCH monitoring occasion in the second search space set.

In one embodiment, “the second CORESET is associated with the second search space set” comprises: the second CORESET comprising time-frequency resources occupied by one PDCCH monitoring occasion in the second search space set.

In one embodiment, “the second CORESET is associated with the second search space set” comprises: REs occupied by the second CORESET including REs occupied by one PDCCH monitoring occasion in the second search space set.

In one embodiment, “the second CORESET is associated with the second search space set” comprises: RBs occupied by the second CORESET in frequency domain including RBs occupied by one PDCCH monitoring occasion in the second search space set.

In one embodiment, “the second CORESET is associated with the second search space set” comprises: frequency-domain resources occupied by the second CORESET including frequency-domain resources occupied by one PDCCH monitoring occasion in the second search space set.

In one embodiment, “the second CORESET is associated with the second search space set” comprises: symbols occupied by the second CORESET being used to determine symbols occupied by one PDCCH monitoring occasion in the second search space set.

In one embodiment, “the second CORESET is associated with the second search space set” comprises: symbols occupied by the second CORESET including symbols occupied by one PDCCH monitoring occasion in the second search space set.

In one embodiment, “the third CORESET is associated with the third search space set” comprises: the configuration information of the third search space set including an index of the third CORESET.

In one embodiment, “the third CORESET is associated with the third search space set” comprises: the third search space set being a search space set configured with an index of the third CORESET.

In one embodiment, “the third CORESET is associated with the third search space set” comprises: the third CORESET being used to determine time-frequency resources occupied by one PDCCH monitoring occasion in the third search space set.

In one embodiment, “the third CORESET is associated with the third search space set” comprises: the third CORESET comprising time-frequency resources occupied by one PDCCH monitoring occasion in the third search space set.

In one embodiment, “the third CORESET is associated with the third search space set” comprises: REs occupied by the third CORESET including REs occupied by one PDCCH monitoring occasion in the third search space set.

In one embodiment, “the third CORESET is associated with the third search space set” comprises: RBs occupied by the third CORESET in frequency domain including RBs occupied by one PDCCH monitoring occasion in the third search space set.

In one embodiment, “the third CORESET is associated with the third search space set” comprises: frequency-domain resources occupied by the third CORESET including frequency-domain resources occupied by one PDCCH monitoring occasion in the third search space set.

In one embodiment, “the third CORESET is associated with the third search space set” comprises: symbols occupied by the third CORESET being used to determine symbols occupied by one PDCCH monitoring occasion in the third search space set.

In one embodiment, “the third CORESET is associated with the third search space set” comprises: symbols occupied by the third CORESET including symbols occupied by one PDCCH monitoring occasion in the third search space set.

In one embodiment, the specific definition of the RE can be found in 3GPP TS 38.211, Section 4.

In one embodiment, a TCI state includes parameters for configuring QCL information between DMRS of a PDSCH, DMRS of a PDCCH, or one or more CSI-RS ports of a CSI-RS (i.e., Channel State Information-Reference Signal) resource and one or two Reference Signals (RSs), and provides an RS for reference for determining the uplink transmit spatial filter (UL Tx spatial filter) of PUSCH (i.e., Physical Uplink Shared Channel) and PUCCH (i.e., Physical Uplink Control Channel) resources and SRS (i.e., Sounding Reference Signal).

In one embodiment, a TCI state includes parameters for configuring QCL information between DMRS of a PDSCH, DMRS of a PDCCH, or one or more CSI-RS ports of a CSI-RS resource and one or two RSs, or, alternatively, provides RS(s) for reference for determining the uplink transmit spatial filter (UL Tx spatial filter) of PUSCH and PUCCH resources and SRS.

In one embodiment, the meaning of “a TCI state indicating QCL information” comprises: the TCI state indicating an RS resource providing QCL information.

In one subembodiment, the meaning of “the TCI state indicating an RS resource providing QCL information” comprises: the TCI state indicating an index of an RS resource providing QCL information.

In one subembodiment, the meaning of “the TCI state indicating an RS resource providing QCL information” comprises: the TCI state indicating an identifier of an RS resource providing QCL information.

In one embodiment, the meaning of “a TCI state indicating QCL information” comprises: the TCI state indicating a serving cell configured with an RS resource providing QCL information.

In one subembodiment, the meaning of “the TCI state indicating a serving cell configured with an RS resource providing QCL information” comprises: the TCI state indicating an index of a serving cell configured with an RS resource providing QCL information.

In one subembodiment, the meaning of “the TCI state indicating a serving cell configured with an RS resource providing QCL information” comprises: the TCI state indicating an identifier of a serving cell configured with an RS resource providing QCL information.

In one embodiment, the meaning of “a TCI state indicating QCL information” comprises: the TCI state indicating a BandWidth Part (BWP) in which an RS resource providing QCL information is located.

In one subembodiment, the meaning of “the TCI state indicating a BWP in which an RS resource providing QCL information is located” comprises: the TCI state indicating an identifier of a BWP in which an RS resource providing QCL information is located.

In one subembodiment, the meaning of “the TCI state indicating a BWP in which an RS resource providing QCL information is located” comprises: the TCI state indicating an index of a BWP in which an RS resource providing QCL information is located.

In one embodiment, the meaning of “a TCI state indicating QCL information” comprises: the TCI state indicating a QCL type.

In one embodiment, the meaning of “a TCI state indicating QCL information” comprises: the TCI state indicating at least the first two of an RS resource providing QCL information, a QCL type, a serving cell configured with an RS resource providing QCL information, and a BWP in which the RS resource providing QCL information resides.

In one embodiment, the meaning of “a TCI state indicating QCL information” comprises: the TCI state indicating an RS resource providing QCL information, a QCL type, a serving cell configured with an RS resource providing QCL information, and a BWP in which the RS resource providing QCL information resides.

In one embodiment, “the TCI state indicates an RS resource that provides QCL information” means: the TCI state indicating the RS resource that provides QCL information for a DMRS antenna port for PDCCH reception.

In one embodiment, “the TCI state indicates an RS resource that provides QCL information” means: the TCI state indicating the RS resource that is quasi co-located with a DMRS antenna port for PDCCH reception.

In one embodiment, “the TCI state indicating a QCL type” means: the TCI state indicating a QCL type between the RS resource providing QCL information indicated by the TCI state and a DMRS antenna port for PDCCH reception.

In one embodiment, “the TCI state indicating a QCL type” means: the TCI state indicating a QCL type corresponding to the RS resource providing QCL information indicated by the TCI state.

In one embodiment, “the TCI state indicating a QCL type” means: the TCI state indicating a QCL type that the RS resource providing QCL information indicated by the TCI state is configured with.

In one embodiment, the QCL type includes: TypeA, TypeB, TypeC and TypeD.

In one embodiment, a QCL type indicated by the TCI state is one of TypeA, TypeB, TypeC, or TypeD.

In one embodiment, a QCL type indicated by the TCI state is TypeA.

In one embodiment, a QCL type indicated by the TCI state is TypeD.

In one embodiment, a QCL type includes at least one type of QCL parameter.

In one embodiment, a QCL parameter whose QCL type is “TypeA” includes: Doppler shift, Doppler spread, average delay, and delay spread.

In one embodiment, a QCL parameter whose QCL type is “TypeB” includes: Doppler shift and Doppler spread.

In one embodiment, a QCL parameter whose QCL type is “TypeC” includes: Doppler shift and average delay.

In one embodiment, a QCL parameter whose QCL type is “TypeD” includes: Spatial Rx parameter.

In one embodiment, the “quasi co-located” means that large-scale properties of a channel through which symbols at one antenna port are transmitted can be inferred from large-scale properties of a channel through which symbols at another antenna port are transmitted.

In one embodiment, the large-scale properties include one or more of delay spread, average delay, Doppler spread, Doppler shift, Spatial Rx parameter, and average gain.

In one embodiment, the large-scale properties include one or more of delay spread, average delay, Doppler spread, Doppler shift, and Spatial Rx parameter.

In one embodiment, the large-scale properties include delay spread, average delay, Doppler spread, Doppler shift, and Spatial Rx parameter.

In one embodiment, the antenna port comprises an RS port.

In one embodiment, the antenna port comprises a DMRS port

In one embodiment, the antenna port comprises a CSI-RS port.

In one embodiment, the antenna port comprises an SRS port.

In one embodiment, the “quasi co-located” means having at least one identical QCL parameter.

In one embodiment, the “quasi co-located” means having the same QCL parameters.

In one embodiment, the “quasi co-located” means having the same QCL parameter of TypeD.

In one embodiment, the “quasi co-located” means: having the same Spatial Rx parameter.

In one embodiment, configuration information of a CORESET includes at least one TCI state.

In one embodiment, configuration information of a CORESET includes one or two TCI states.

In one embodiment, when the configuration information of a CORESET comprises two TCI states, the two TCI states in the configuration information of the CORESET indicate, respectively, QCL information for a DMRS antenna port for PDCCH reception in the CORESET outside of the reference time-domain resource and QCL information for a DMRS antenna port for PDCCH reception in the CORESET in the reference time-domain resource.

In one embodiment, when the configuration information of a CORESET comprises two TCI states, one of the two TCI states in the configuration information of the CORESET indicates QCL information for a DMRS antenna port for PDCCH reception in the CORESET outside of the reference time-domain resource and the other one of the two TCI states in the configuration information of the CORESET indicates QCL information for a DMRS antenna port for PDCCH reception in the CORESET in the reference time-domain resource.

In one embodiment, two TCI states included in the configuration information of the first CORESET are a first TCI state and a second TCI state; the first TCI state and the second TCI state are indicative of QCL information for a DMRS antenna port for PDCCH reception in the first CORESET outside of the reference time-domain resource set and QCL information for a DMRS antenna port for PDCCH reception in the first CORESET in the reference time-domain resource set, respectively.

In one embodiment, the first TCI state indicates that a DMRS antenna port for PDCCH reception in the first CORESET outside of the reference time-domain resource set is quasi co-located with a first RS resource, and the second TCI state indicates that a DMRS antenna port for PDCCH reception in the first CORESET in the reference time-domain resource set is quasi co-located with a second RS resource.

In one embodiment, at least one TCI state included in the configuration information of the second CORESET includes a third TCI state; the third TCI state indicates QCL information for a DMRS antenna port for PDCCH reception in the second CORESET outside of the reference time-domain resource set.

In one embodiment, the third TCI state indicates that a DMRS antenna port for PDCCH reception in the second CORESET outside of the reference time-domain resource set is quasi co-located with a third RS resource.

In one embodiment, at least one TCI state included in the configuration information of the third CORESET includes a fourth TCI state; the fourth TCI state indicates QCL information for a DMRS antenna port for PDCCH reception in the third CORESET in the reference time-domain resource set.

In one embodiment, the fourth TCI state indicates that a DMRS antenna port for PDCCH reception in the third CORESET in the reference time-domain resource set is quasi co-located with a fourth RS resource.

In one embodiment, the first TCI state is a TCI state.

In one embodiment, the second TCI state is a TCI state.

In one embodiment, the third TCI state is a TCI state.

In one embodiment, the fourth TCI state is a TCI state.

In one embodiment, the first TCI state indicates the first RS resource.

In one embodiment, the second TCI state indicates the second RS resource.

In one embodiment, the third TCI state indicates the third RS resource.

In one embodiment, the fourth TCI state indicates the fourth RS resource.

In one embodiment, an RS resource indicated by the first TCI state which is configured with a QCL type of “TypeD” is the first RS resource.

In one embodiment, an RS resource indicated by the second TCI state which is configured with a QCL type of “TypeD” is the second RS resource.

In one embodiment, an RS resource indicated by the third TCI state which is configured with a QCL type of “TypeD” is the third RS resource.

In one embodiment, an RS resource indicated by the fourth TCI state which is configured with a QCL type of “TypeD” is the fourth RS resource.

In one embodiment, the first RS resource is an RS resource that provides QCL information.

In one embodiment, the second RS resource is an RS resource that provides QCL information.

In one embodiment, the third RS resource is an RS resource that provides QCL information.

In one embodiment, the fourth RS resource is an RS resource that provides QCL information.

In one embodiment, the first RS resource is an RS resource providing QCL information for a DMRS antenna port for PDCCH reception in the first CORESET outside of the reference time-domain resource set.

In one embodiment, the second RS resource is an RS resource providing QCL information for a DMRS antenna port for PDCCH reception in the first CORESET in the reference time-domain resource set.

In one embodiment, the third RS resource is an RS resource providing QCL information for a DMRS antenna port for PDCCH reception in the second CORESET outside of the reference time-domain resource set.

In one embodiment, the fourth RS resource is an RS resource providing QCL information for a DMRS antenna port for PDCCH reception in the third CORESET in the reference time-domain resource set.

In one embodiment, the first TCI state indicates a QCL type corresponding to the first RS resource.

In one embodiment, the second TCI state indicates a QCL type corresponding to the second RS resource.

In one embodiment, the third TCI state indicates a QCL type corresponding to the third RS resource.

In one embodiment, the fourth TCI state indicates a QCL type corresponding to the fourth RS resource.

In one embodiment, the first TCI state indicates that a QCL type corresponding to the first RS resource includes TypeD.

In one embodiment, the second TCI state indicates that a QCL type corresponding to the second RS resource includes TypeD.

In one embodiment, the third TCI state indicates that a QCL type corresponding to the third RS resource includes TypeD.

In one embodiment, the fourth TCI state indicates that a QCL type corresponding to the fourth RS resource includes TypeD.

In one embodiment, the first RS resource comprises downlink RS.

In one embodiment, the second RS resource comprises downlink RS.

In one embodiment, the third RS resource comprises downlink RS.

In one embodiment, the fourth RS resource comprises downlink RS.

In one embodiment, the first RS resource comprises a CSI-RS resource.

In one embodiment, the second RS resource comprises a CSI-RS resource.

In one embodiment, the third RS resource comprises a CSI-RS resource.

In one embodiment, the fourth RS resource comprises a CSI-RS resource.

In one embodiment, the first RS resource comprises a Synchronization Signal/Physical Broadcast Channel (SS/PBCH) block resource.

In one embodiment, the second RS resource comprises a Synchronization Signal/Physical Broadcast Channel (SS/PBCH) block resource.

In one embodiment, the third RS resource comprises a Synchronization Signal/Physical Broadcast Channel (SS/PBCH) block resource.

In one embodiment, the fourth RS resource comprises a Synchronization Signal/Physical Broadcast Channel (SS/PBCH) block resource.

In one embodiment, the first RS resource is a CSI-RS resource or an SS/PBCH block resource.

In one embodiment, the second RS resource is a CSI-RS resource or an SS/PBCH block resource.

In one embodiment, the third RS resource is a CSI-RS resource or an SS/PBCH block resource.

In one embodiment, the fourth RS resource is a CSI-RS resource or an SS/PBCH block resource.

In one embodiment, the configuration information of the first CORESET comprises two TCI states; the two TCI states in the configuration information of the first CORESET are each indicative of QCL information for a DMRS antenna port for PDCCH reception in the first CORESET on two types of symbols.

In one embodiment, only one type of symbols of the two types of symbols are used for DownLink (DL) transmission only.

In one embodiment, only one type of symbols of the two types of symbols support UpLink (UL) transmission.

In one embodiment, only one type of symbols of the two types of symbols support DL transmission and UL transmission.

In one embodiment, one type of symbols of the two types of symbols support DL transmission only, while the other type of symbols of the two types of symbols support both DL transmission and UL transmission.

In one embodiment, both of the two types of symbols are configured as DL by a higher layer parameter; one type of symbols of the two types of symbols support DL transmission only, while the other type of symbols of the two types of symbols support both DL transmission and UL transmission.

In one embodiment, either type of symbols of the two types of symbols are configured as DL or Flexible by a higher layer parameter.

In one embodiment, both of the two types of symbols are configured as DL by a higher layer parameter.

In one embodiment, either type of symbols of the two types of symbols are configured as DL or Flexible by a higher layer parameter; the two types of symbols are SBFD symbols and non-SBFD symbols, respectively.

In one embodiment, the two types of symbols are SBFD symbols and non-SBFD symbols, respectively.

In one embodiment, the two types of symbols support SBFD and non-SBFD respectively.

In one embodiment, the non-SBFD symbol is a DL symbol.

In one embodiment, the non-SBFD symbol is a DL symbol or a Flexible symbol.

In one embodiment, the two types of symbols are of a first type and a type other than the first type, respectively.

In one embodiment, a type other than the first type includes DL or Flexible.

In one embodiment, a type other than the first type is DL or Flexible.

In one embodiment, the two types of symbols are of different types, and the two types of symbols are of a first type and DL.

In one embodiment, the two types of symbols are of different types.

In one embodiment, one type of symbols of the two types of symbols are of a first type and the other type of symbols of the two types of symbols are of DL.

In one embodiment, one type of symbols of the two types of symbols are of a first type and the other type of symbols of the two types of symbols are of DL or Flexible.

In one embodiment, the symbol of the first type is a SBFD symbol.

In one embodiment, both of the two types of symbols are configured as DL by a higher layer parameter; one type of symbols of the two types of symbols are of a first type and the other type of symbols of the two types of symbols are of DL.

In one embodiment, both of the two types of symbols are configured as DL or Flexible by a higher layer parameter; one type of symbols of the two types of symbols are of a first type and the other type of symbols of the two types of symbols are of DL or Flexible.

In one embodiment, symbols of a first type are configured as DL by a higher layer parameter, and one or more subcarriers in the symbols of the first type are used for UL transmission.

In one embodiment, symbols of a first type are configured as DL by a higher layer parameter, and one or more RBs in the symbols of the first type are used for UL transmission.

In one embodiment, symbols of a first type are configured as DL by a higher layer parameter, and the symbols of the first type support UL transmission.

In one embodiment, if a symbol is configured or indicated as the first type, the symbol is used in a full duplex/SBFD mode.

In one embodiment, if a symbol is configured or indicated as the first type, the symbol is used for both uplink and downlink.

In one embodiment, if a symbol is configured or indicated as the first type, the symbol is used for uplink on one part of RBs and for downlink on the other part of the RBs.

In one subembodiment, the one part of RBs and the other part of the RBs belong to a same serving cell.

In one subembodiment, the one part of RBs and the other part of the RBs belong to a same BWP.

In one embodiment, if a symbol is configured or indicated as a type different from the first type, the symbol is not used in a full duplex/SBFD mode.

In one embodiment, if a symbol is configured or indicated as a type different from the first type, the symbol is used for uplink only or for downlink only.

In one embodiment, the higher layer parameter is an RRC parameter.

In one embodiment, the higher layer parameter includes tdd-UL-DL-ConfigurationCommon.

In one embodiment, the higher layer parameter includes tdd-UL-DL-ConfigurationDedicated.

In one embodiment, the higher layer parameter includes tdd-UL-DL-ConfigurationCommon and tdd-UL-DL-ConfigurationDedicated.

In one embodiment, the higher layer parameter includes at least one of tdd-UL-DL-ConfigurationCommon or tdd-UL-DL-ConfigurationDedicated.

In one embodiment, the specific definitions of tdd-UL-DL-ConfigurationCommon and tdd-UL-DL-ConfigurationDedicated can be found in 3GPP TS38.213, Section 11.

In one embodiment, the configuration information of the first CORESET comprises two TCI states, one of the two TCI states in the configuration information of the first CORESET indicates QCL information for a DMRS antenna port for PDCCH reception in the first CORESET on one type of symbols of the two types of symbols, while the other one of the two TCI states in the configuration information of the first CORESET indicates QCL information for a DMRS antenna port for PDCCH reception in the first CORESET on the other type of symbols of the two types of symbols.

In one embodiment, the configuration information of the first CORESET comprises two TCI states, one of the two TCI states in the configuration information of the first CORESET indicates QCL information for a DMRS antenna port for PDCCH reception in the first CORESET on symbols of the first type, while the other one of the two TCI states in the configuration information of the first CORESET indicates QCL information for a DMRS antenna port for PDCCH reception in the first CORESET on symbols of a type other than the first type.

In one embodiment, the second TCI state indicates QCL information for a DMRS antenna port for PDCCH reception in the first CORESET on symbols of the first type, while the first TCI state indicates QCL information for a DMRS antenna port for PDCCH reception in the first CORESET on symbols of a type other than the first type.

In one embodiment, the third TCI state indicates QCL information for a DMRS antenna port for PDCCH reception in the second CORESET on a symbol of a type other than the first type.

In one embodiment, the fourth TCI state indicates QCL information for a DMRS antenna port for PDCCH reception in the third CORESET on a symbol of the first type.

In one embodiment, an advantage of the above method includes: reducing interference of receiving PDCCH in different types of symbols.

### Embodiments 11A-11B

Embodiments 11A-11B each illustrate a schematic diagram of a reference time-domain resource set and two types of symbols according to one embodiment of the present application; as shown in FIG. 11A-FIG. 11B.

In Embodiment 11A, the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission.

In one embodiment, the reference time-domain resource set comprises one or more symbols, and at least one symbol in the reference time-domain resource set is configured as DL symbols by a higher layer parameter, and one or more RBs in one or more symbols in the reference time-domain resource set configured as DL by the higher layer parameter is/are used for uplink transmission.

In one embodiment, any symbol in the reference time-domain resource set is configured as DL by a higher layer parameter.

In one embodiment, any symbol in the reference time-domain resource set is configured as DL or Flexible by a higher layer parameter.

In one embodiment, each symbol in the reference time-domain resource set is configured as DL by a higher layer parameter.

In one embodiment, each symbol in the reference time-domain resource set is configured as DL or Flexible by a higher layer parameter.

In one embodiment, at least one symbol in the reference time-domain resource set is configured as DL by a higher layer parameter, and at least one symbol in the reference time-domain resource set is configured as Flexible by a higher layer parameter.

In one embodiment, the reference time-domain resource set is configured to a serving cell.

In one embodiment, the reference time-domain resource set is configured to at least one BandWidth Part (BWP).

In one embodiment, the reference time-domain resource set is configured to a BWP.

In one embodiment, the reference time-domain resource set is configured to a DL BWP.

In one embodiment, the reference time-domain resource set is configured to a DL BWP in which the first RS resource is located.

In one embodiment, the reference time-domain resource set is configured to a pair of DL BWP and UL BWP.

In one embodiment, the higher layer parameter is carried by an RRC signaling.

In one embodiment, the higher layer parameter comprises all or part of fields in one RRC IE.

In one embodiment, the higher layer parameter comprises all or part of fields in each one of multiple RRC IEs.

In one embodiment, the higher layer parameter comprises all or part of fields in a TDD-UL-DL-ConfigCommon IE.

In one embodiment, the higher layer parameter comprises all or part of fields in a TDD-UL-DL-ConfigDedicated IE.

In one embodiment, the higher layer parameter comprises all or part of fields in a ServingCellConfig IE.

In one embodiment, the higher layer parameter comprises all or part of fields in a ServingCellConfigCommonSIB IE.

In one embodiment, the higher layer parameter comprises information in all or part of fields in a ServingCellConfigCommon IE.

In one embodiment, the higher layer parameter is carried by at least one RRC IE.

In one embodiment, a name of an IE carrying the higher layer parameter includes TDD-UL-DL-Config.

In one embodiment, a name of an IE carrying the higher layer parameter includes ServingCellConfig.

In one embodiment, the uplink transmission in one or more symbols in the reference time-domain resource set configured as DL by the higher layer parameter comprises at least one of a Physical Uplink Shared Channel (PUSCH), a Physical Uplink Control Channel (PUCCH), a Physical Random-Access Channel (PRACH) or a Sounding Reference Signal (SRS).

In one embodiment, the uplink transmission in one or more symbols in the reference time-domain resource set configured as DL by the higher layer parameter comprises a PUSCH.

In one embodiment, the uplink transmission in one or more symbols in the reference time-domain resource set configured as DL by the higher layer parameter comprises a PUCCH.

In one embodiment, the uplink transmission in one or more symbols in the reference time-domain resource set configured as DL by the higher layer parameter comprises a PRACH.

In one embodiment, the uplink transmission in one or more symbols in the reference time-domain resource set configured as DL by the higher layer parameter comprises an SRS.

In one embodiment, the first receiver receives a fourth information block; where the fourth information block is used to determine a reference frequency-domain resource set; a UL transmission in one or more DL symbols of the reference time-domain resource set belongs to the reference frequency-domain resource set in frequency domain.

In one embodiment, the fourth information block is borne by a higher layer signaling.

In one embodiment, the fourth information block is borne by an RRC signaling.

In one embodiment, the fourth information block comprises partial or all fields in one or more RRC IEs.

In one embodiment, the fourth information block comprises partial fields in multiple RRC IEs.

In one embodiment, the fourth information block comprises all or partial fields in one RRC IE.

In one embodiment, the fourth information block comprises partial fields in one RRC IE.

In one embodiment, the fourth information block is borne by a MAC CE signaling.

In one embodiment, the fourth information block is borne by a physical layer signaling.

In one embodiment, the fourth information block is borne by a DCI signaling.

In one embodiment, the fourth information block and the first information block are borne by a same RRC IE.

In one embodiment, the fourth information block and the first information block are borne by two RRC IEs, respectively.

In one embodiment, the fourth information block and the first information block are received together.

In one embodiment, the reference frequency-domain resource set comprises part or all of RBs of a DL BWP.

In one embodiment, the reference frequency-domain resource set comprises part of RBs of a DL BWP.

In one embodiment, the reference frequency-domain resource set comprises part or all of RBs of a UL BWP.

In one embodiment, the reference frequency-domain resource set comprises part of RBs of a UL BWP.

In one embodiment, the reference frequency-domain resource set comprises part or all of RBs of a UL BWP in a pair of DL BWP and UL BWP.

In one embodiment, the reference frequency-domain resource set comprises part of RBs of a UL BWP in a pair of DL BWP and UL BWP.

In one embodiment, on one serving cell, a UL transmission in one or more DL symbols of the reference time-domain resource set belongs to the reference frequency-domain resource set in frequency domain.

In one embodiment, on one BWP, a UL transmission in one or more DL symbols of the reference time-domain resource set belongs to the reference frequency-domain resource set in frequency domain.

In one embodiment, on one DL BWP, a UL transmission in one or more DL symbols of the reference time-domain resource set belongs to the reference frequency-domain resource set in frequency domain.

In one embodiment, on one UL BWP in a pair of DL BWP and UL BWP, a UL transmission in one or more DL symbols of the reference time-domain resource set belongs to the reference frequency-domain resource set in frequency domain.

In one embodiment, on a serving cell where the fourth information block or the first information block is transmitted, a UL transmission in one or more DL symbols of the reference time-domain resource set belongs to the reference frequency-domain resource set in frequency domain.

In one embodiment, on a BWP where the fourth information block or the first information block is transmitted, a UL transmission in one or more DL symbols of the reference time-domain resource set belongs to the reference frequency-domain resource set in frequency domain.

In one embodiment, on a DL BWP where the fourth information block or the first information block is transmitted, a UL transmission in one or more DL symbols of the reference time-domain resource set belongs to the reference frequency-domain resource set in frequency domain.

In one embodiment, on the UL BWP in a pair of DL BWP and UL BWP to which the DL BWP where the fourth information block or the first information block is transmitted belongs, a UL transmission in one or more DL symbols of the reference time-domain resource set belongs to the reference frequency-domain resource set in frequency domain.

In one embodiment, the reference time-domain resource set is configured to a serving cell, and the reference frequency-domain resource set is configured to the serving cell; on the serving cell, the uplink transmission in at least one symbol of the reference time-domain resource set being configured as DL by the higher layer parameter belongs to the reference frequency-domain resource set in frequency domain.

In one embodiment, the reference time-domain resource set is configured to a serving cell, and the reference frequency-domain resource set is configured to the serving cell; on one BWP of the serving cell, the uplink transmission in at least one symbol of the reference time-domain resource set being configured as DL by the higher layer parameter belongs to frequency-domain resources where the reference frequency-domain resource set and the BWP of the serving cell are overlapping in frequency domain.

In one embodiment, the reference time-domain resource set is configured to a serving cell, and the reference frequency-domain resource set is configured to the serving cell; on one UL BWP of the serving cell, the uplink transmission in at least one symbol of the reference time-domain resource set being configured as DL by the higher layer parameter belongs to frequency-domain resources where the reference frequency-domain resource set and the UL BWP of the serving cell are overlapping in frequency domain.

In one embodiment, “the reference time-domain resource set is configured to a serving cell” comprises that information indicating the reference time-domain resource set is a part of configuration information of a serving cell.

In one embodiment, “the reference time-domain resource set is configured to a serving cell” comprises that the reference time-domain resource set is applied to all BWPs of a serving cell.

In one embodiment, “the reference time-domain resource set is configured to a serving cell” comprises that information indicating the reference time-domain resource set is a part of an IE ServingCellConfig used to configure a serving cell.

In one embodiment, “the reference time-domain resource set is configured to a serving cell” comprises that information indicating the reference time-domain resource set is a part of an IE ServingCellConfigCommon used to configure a serving cell.

In one embodiment, “the reference time-domain resource set is configured to a serving cell” comprises that information indicating the reference time-domain resource set is a part of at least one of an IE ServingCellConfig or an IE ServingCellConfigCommon used to configure a serving cell.

In one embodiment, “the reference frequency-domain resource set is configured to the serving cell” comprises that information indicating the reference frequency-domain resource set is a part of configuration information of the serving cell.

In one embodiment, “the reference frequency-domain resource set is configured to the serving cell” comprises that the reference frequency-domain resource set is applied to all BWPs of the serving cell.

In one embodiment, “the reference frequency-domain resource set is configured to the serving cell” comprises that the reference frequency-domain resource set and BWPs of the serving cell are separately configured.

In one embodiment, “the reference frequency-domain resource set is configured to the serving cell” comprises that information indicating the reference frequency-domain resource set is a part of an IE ServingCellConfig used to configure the serving cell.

In one embodiment, “the reference frequency-domain resource set is configured to the serving cell” comprises that information indicating the reference frequency-domain resource set is a part of an IE ServingCellConfigCommon used to configure the serving cell.

In one embodiment, “the reference frequency-domain resource set is configured to the serving cell” comprises that information indicating the reference frequency-domain resource set is a part of at least one of an IE ServingCellConfig or an IE ServingCellConfigCommon used to configure the serving cell.

In one embodiment, “the reference time-domain resource set is configured to a serving cell” comprises that information indicating the reference time-domain resource set is a part of configuration information of a serving cell; “the reference frequency-domain resource set is configured to the serving cell” comprises that information indicating the reference frequency-domain resource set is a part of configuration information of the serving cell.

In one embodiment, “the reference time-domain resource set is configured to a serving cell” comprises that information indicating the reference time-domain resource set is a part of an IE ServingCellConfig used to configure a serving cell; “the reference frequency-domain resource set is configured to the serving cell” comprises that information indicating the reference frequency-domain resource set is a part of an IE ServingCellConfig used to configure the serving cell.

In one embodiment, “the reference time-domain resource set is configured to a serving cell” comprises that information indicating the reference time-domain resource set is a part of an IE ServingCellConfigCommon used to configure a serving cell; “the reference frequency-domain resource set is configured to the serving cell” comprises that information indicating the reference frequency-domain resource set is a part of an IE ServingCellConfigCommon used to configure the serving cell.

In one embodiment, the reference time-domain resource set is configured to at least one BWP, and the reference frequency-domain resource set is configured to the at least one BWP; on any BWP of the at least one BWP, the uplink transmission in at least one symbol of the reference time-domain resource set being configured as DL by the higher layer parameter belongs to the reference frequency-domain resource set in frequency domain.

In one embodiment, the reference time-domain resource set is configured to at least one BWP, and the reference frequency-domain resource set is configured to the at least one BWP; a given BWP is any BWP of the at least one BWP, and on the given BWP, the uplink transmission in at least one symbol of the reference time-domain resource set being configured as DL by the higher layer parameter belongs to frequency-domain resources where the reference frequency-domain resource set and the given BWP are overlapping in frequency domain.

In one embodiment, the reference time-domain resource set is configured to at least one BWP, and the reference frequency-domain resource set is configured to the at least one BWP; on one UL BWP of the at least one BWP, the uplink transmission in at least one symbol of the reference time-domain resource set being configured as DL by the higher layer parameter belongs to the reference frequency-domain resource set in frequency domain.

In one embodiment, the reference time-domain resource set is configured to at least one BWP, and the reference frequency-domain resource set is configured to the at least one BWP; a given BWP is a UL BWP of the at least one BWP, and on the given BWP, the uplink transmission in at least one symbol of the reference time-domain resource set being configured as DL by the higher layer parameter belongs to frequency-domain resources where the reference frequency-domain resource set and the given BWP are overlapping in frequency domain.

In one embodiment, “the reference time-domain resource set is configured to at least one BWP” comprises that information indicating the reference time-domain resource set is a part of configuration information of the at least one BWP.

In one embodiment, “the reference time-domain resource set is configured to at least one BWP” comprises that the reference time-domain resource set is applied to the at least one BWP.

In one embodiment, “the reference frequency-domain resource set is configured to at least one BWP” comprises that information indicating the reference frequency-domain resource set is a part of configuration information of the at least one BWP.

In one embodiment, “the reference frequency-domain resource set is configured to at least one BWP” comprises that the reference frequency-domain resource set is applied to the at least one BWP.

In one embodiment, “the reference frequency-domain resource set is configured to at least one BWP” comprises that the reference frequency-domain resource set is a part of the at least one BWP.

In one embodiment, “the reference frequency-domain resource set is configured to at least one BWP” comprises that the reference frequency-domain resource set comprises part of or all frequency-domain resources in each BWP of the at least one BWP.

In one embodiment, the reference time-domain resource set is configured to a BWP, and the reference frequency-domain resource set is configured to the BWP; on the BWP, the uplink transmission in at least one symbol of the reference time-domain resource set being configured as DL by the higher layer parameter belongs to the reference frequency-domain resource set in frequency domain.

In one embodiment, “the reference time-domain resource set is configured to a BWP” comprises that information indicating the reference time-domain resource set is a part of configuration information of a BWP.

In one embodiment, “the reference time-domain resource set is configured to a BWP” comprises that the reference time-domain resource set is applied to a BWP.

In one embodiment, “the reference frequency-domain resource set is configured to the BWP” comprises that information indicating the reference frequency-domain resource set is a part of configuration information of the BWP.

In one embodiment, “the reference frequency-domain resource set is configured to the BWP” comprises that the reference frequency-domain resource set is applied to the BWP.

In one embodiment, “the reference frequency-domain resource set is configured to the BWP” comprises that the reference frequency-domain resource set is a part of the BWP.

In one embodiment, the reference time-domain resource set is configured to a pair of DL BWP and UL BWP, and the reference frequency-domain resource set is configured to the pair of DL BWP and UL BWP; on the UL BWP in the pair of DL BWP and UL BWP, the uplink transmission in at least one symbol of the reference time-domain resource set being configured as DL by the higher layer parameter belongs to the reference frequency-domain resource set in frequency domain.

In one embodiment, “the reference time-domain resource set is configured to a pair of DL BWP and UL BWP” comprises that information indicating the reference time-domain resource set is a part of configuration information of the DL BWP in the pair of DL BWP and UL BWP, or, is a part of configuration information of the UL BWP in the pair of DL BWP and UL BWP.

In one embodiment, “the reference time-domain resource set is configured to a pair of DL BWP and UL BWP” comprises that the reference time-domain resource set is applied to the pair of DL BWP and UL BWP.

In one embodiment, “the reference frequency-domain resource set is configured to the pair of DL BWP and UL BWP” comprises that information indicating the reference frequency-domain resource set is a part of configuration information of the DL BWP in the pair of DL BWP and UL BWP, or, is a part of configuration information of the UL BWP in the pair of DL BWP and UL BWP.

In one embodiment, “the reference frequency-domain resource set is configured to the pair of DL BWP and UL BWP” comprises that the reference frequency-domain resource set is applied to the pair of DL BWP and UL BWP.

In one embodiment, “the reference frequency-domain resource set is configured to the pair of DL BWP and UL BWP” comprises that the reference frequency-domain resource set is a part of the DL BWP in the pair of DL BWP and UL BWP.

In one embodiment, the reference time-domain resource set is configured to a DL BWP, and the reference frequency-domain resource set is configured to the DL BWP; a first UL BWP is the UL BWP in a pair of DL BWP and UL BWP to which the DL BWP belongs; on the first UL BWP, the uplink transmission in at least one symbol of the reference time-domain resource set being configured as DL by the higher layer parameter belongs to the reference frequency-domain resource set in frequency domain.

In one embodiment, “the reference time-domain resource set is configured to a DL BWP” comprises that information indicating the reference time-domain resource set is a part of configuration information of the DL BWP.

In one embodiment, “the reference time-domain resource set is configured to a DL BWP” comprises that the reference time-domain resource set is applied to the DL BWP.

In one embodiment, “the reference frequency-domain resource set is configured to a DL BWP” comprises that information indicating the reference frequency-domain resource set is a part of configuration information of the DL BWP.

In one embodiment, “the reference frequency-domain resource set is configured to a DL BWP” comprises that the reference frequency-domain resource set is applied to the DL BWP.

In one embodiment, “the reference frequency-domain resource set is configured to a DL BWP” comprises that the reference frequency-domain resource set is a part of the DL BWP.

In one embodiment, the fourth information block is used by the first node to determine a reference frequency-domain resource set.

In one embodiment, the fourth information block indicates the reference frequency-domain resource set.

In one embodiment, “the fourth information block indicates the reference frequency-domain resource set” means that the fourth information block explicitly indicates the reference frequency-domain resource set.

In one embodiment, “the fourth information block indicates the reference frequency-domain resource set” means that the fourth information block implicitly indicates the reference frequency-domain resource set.

In one embodiment, the fourth information block indicates a reference frequency-domain resource pool, the reference frequency-domain resource set being a part of the reference frequency-domain resource pool.

In one embodiment, the fourth information block indicates the reference frequency-domain resource pool, the reference frequency-domain resource set comprising at least one RB in the reference frequency-domain resource pool overlapping with one DL BWP.

In one embodiment, the fourth information block indicates the reference frequency-domain resource pool, the reference frequency-domain resource set comprising all RBs in the reference frequency-domain resource pool overlapping with one DL BWP.

In one embodiment, the fourth information block indicates the reference frequency-domain resource pool, the reference frequency-domain resource set comprising at least one RB in the reference frequency-domain resource pool overlapping with a DL BWP where the fourth information block or the first information block is transmitted.

In one embodiment, the fourth information block indicates the reference frequency-domain resource pool, the reference frequency-domain resource set comprising all RBs in the reference frequency-domain resource pool overlapping with a DL BWP where the fourth information block or the first information block is transmitted.

In one embodiment, the reference frequency-domain resource pool comprises one or more RBs.

In one embodiment, the reference frequency-domain resource pool comprises multiple consecutive RBs.

In Embodiment 11B, two types of symbols are both configured as DL by higher layer parameter(s), the reference time-domain resource set including only one type of symbols of the two types of symbols.

In one embodiment, the reference time-domain resource set includes only symbols of a first type of the two types of symbols.

In one embodiment, the reference time-domain resource set comprises one or more symbols of the first type, and one or more subcarriers in one or more symbols of the first type in the reference time-domain resource set is/are used for uplink transmission.

In one embodiment, the reference time-domain resource set comprises one or more symbols of the first type, and one or more RBs in one or more symbols of the first type in the reference time-domain resource set is/are used for uplink transmission.

In one embodiment, the reference time-domain resource set comprises one or more symbols of the first type, and uplink transmission(s) in one or more symbols of the first type in the reference time-domain resource set is/are part of the reference frequency-domain resource set.

### Embodiment 12

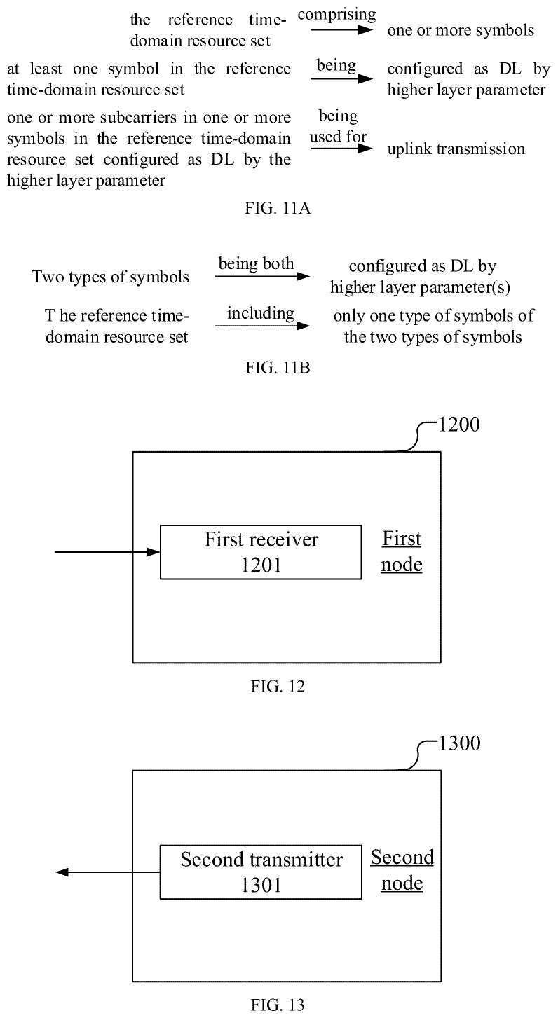

Embodiment 12 illustrates a structure block diagram of a processing device used in a first node according to one embodiment of the present application, as shown in FIG. 12. In FIG. 12, a processing device 1200 in a first node comprises a first receiver 1201.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

The first receiver 1201 receives a second information block, the second information block being used to determine that a first search space set is linked to a second search space set and a third search space set;

the first receiver 1201 receives a first information block, the first information block being used to determine a reference time-domain resource set;

the first receiver 1201 monitors in a first time unit at least first PDCCH candidate in the first search space set and at least target PDCCH candidate in a target search space set.

In Embodiment 12, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, when the first time unit belongs to the reference time-domain resource set, the target search space set is the third search space set.

In one embodiment, when PDCCH monitoring occasion(s) of the second search space set in the first time unit belongs/belong to the reference time-domain resource set, the target search space set is the third search space set.

In one embodiment, when a PDCCH monitoring occasion in which the at least first PDCCH candidate in the first search space set is monitored in the first time unit belongs to the reference time-domain resource set, the target search space set is the third search space set.

In one embodiment, in the first time unit, PDCCH candidates in a search space set of the second search space set and the third search space set other than the target search space set and PDCCH candidates in the first search space set are not monitored to detect a DCI format with identical information.

In one embodiment, in the first time unit, monitoring of the PDCCH candidates is dropped in a search space set of the second search space set and the third search space set other than the target search space set.

In one embodiment, the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set.

In one embodiment, comprising:
the first receiver 1201, receiving a third information block;
herein, the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside of the reference time-domain resource set and QCL information for a DMRS antenna port for PDCCH reception in the first CORESET in the reference time-domain resource set.

In one embodiment, the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission.

In one embodiment, two types of symbols are both configured as DL by higher layer parameter(s), the reference time-domain resource set including only one type of symbols of the two types of symbols.

### Embodiment 13

Embodiment 13 illustrates a structure block diagram of a processing device used in a second node according to one embodiment of the present application, as shown in FIG. 13. In FIG. 13, a processing device 1300 in a second node comprises a second transmitter 1301.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475 or the memory 476 in Embodiment 4.

The second transmitter 1301 transmits a second information block, the second information block being used to determine that a first search space set is linked to a second search space set and a third search space set;

the second transmitter 1301 transmits a first information block, the first information block being used to determine a reference time-domain resource set.

In Embodiment 13, the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

In one embodiment, when the first time unit belongs to the reference time-domain resource set, the target search space set is the third search space set.

In one embodiment, when PDCCH monitoring occasion(s) of the second search space set in the first time unit belongs/belong to the reference time-domain resource set, the target search space set is the third search space set.

In one embodiment, when a PDCCH monitoring occasion in which the at least first PDCCH candidate in the first search space set is monitored in the first time unit belongs to the reference time-domain resource set, the target search space set is the third search space set.

In one embodiment, in the first time unit, PDCCH candidates in a search space set of the second search space set and the third search space set other than the target search space set and PDCCH candidates in the first search space set are not monitored to detect a DCI format with identical information.

In one embodiment, in the first time unit, monitoring of the PDCCH candidates is dropped in a search space set of the second search space set and the third search space set other than the target search space set.

In one embodiment, the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set.

In one embodiment, comprising:
the second transmitter 1301, transmitting a third information block;
herein, the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside of the reference time-domain resource set and QCL information for a DMRS antenna port for PDCCH reception in the first CORESET in the reference time-domain resource set.

In one embodiment, the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission.

In one embodiment, two types of symbols are both configured as DL by higher layer parameter(s), the reference time-domain resource set including only one type of symbols of the two types of symbols.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), GNSS, relay satellite, satellite base station, airborne base station, Road Side Unit (RSU), drones, test equipment (like transceiving device simulating partial functions of base station or signaling tester) and other wireless communication equipment.

The above are merely the preferred embodiments of the present application and are not intended to limit the scope of protection of the present application. Any change or modification made based on the embodiments described in this specification, if, through which similar partial or all technical effects can be obtained, shall be considered apparent and fall within the scope of protection of the present invention.

What is claimed is:

1. A first node for wireless communications, comprising:
a first receiver, receiving a second information block, the second information block being used to determine that a first search space set is linked to a second search space set and a third search space set;
the first receiver, receiving a first information block, the first information block being used to determine a reference time-domain resource set;
the first receiver, monitoring in a first time unit at least first PDCCH candidate in the first search space set and at least target PDCCH candidate in a target search space set;
wherein the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

2. The first node according to claim 1, characterized in that when the first time unit belongs to the reference time-domain resource set, the target search space set is the third search space set; or, when PDCCH monitoring occasion(s) of the second search space set in the first time unit belongs/belong to the reference time-domain resource set, the target search space set is the third search space set; or, when a PDCCH monitoring occasion in which the at least first PDCCH candidate in the first search space set is monitored in the first time unit belongs to the reference time-domain resource set, the target search space set is the third search space set.

3. The first node according to claim 1, characterized in that
in the first time unit, PDCCH candidates in a search space set of the second search space set and the third search space set other than the target search space set and PDCCH candidates in the first search space set are not monitored to detect a DCI format with identical information;
or,
in the first time unit, monitoring of the PDCCH candidates is dropped in a search space set of the second search space set and the third search space set other than the target search space set.

4. The first node according to claim 1, characterized in that
the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set;
or,
comprising: the first receiver, receiving a third information block; wherein the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside the reference time-domain resource set and QCL information for a DMRS antenna port for PDCCH reception in the first CORESET in the reference time-domain resource set.

5. The first node according to claim 1, characterized in that
the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission;
or,
two types of symbols are both configured as DL by higher layer parameter(s), the reference time-domain resource set including only one type of symbols of the two types of symbols.

6. A second node for wireless communications, comprising:
a second transmitter, transmitting a second information block, the second information block being used to determine that a first search space set is linked to a second search space set and a third search space set;
the second transmitter, transmitting a first information block, the first information block being used to determine a reference time-domain resource set;
wherein the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

7. The second node according to claim 6, characterized in that when the first time unit belongs to the reference time-domain resource set, the target search space set is the third search space set; or, when PDCCH monitoring occasion(s) of the second search space set in the first time unit belongs/belong to the reference time-domain resource set, the target search space set is the third search space set; or, when a PDCCH monitoring occasion in which the at least first PDCCH candidate in the first search space set is monitored in the first time unit belongs to the reference time-domain resource set, the target search space set is the third search space set.

8. The second node according to claim 6, characterized in that
in the first time unit, PDCCH candidates in a search space set of the second search space set and the third search space set other than the target search space set and PDCCH candidates in the first search space set are not monitored to detect a DCI format with identical information;
or,
in the first time unit, monitoring of the PDCCH candidates is dropped in a search space set of the second search space set and the third search space set other than the target search space set.

9. The second node according to claim 6, characterized in that
the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set;
or,
comprising: the second transmitter, transmitting a third information block; wherein the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside the reference time-domain resource set and QCL information for a DMRS antenna port for PDCCH reception in the first CORESET in the reference time-domain resource set.

10. The second node according to claim 6, characterized in that
the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission;
or,
two types of symbols are both configured as DL by higher layer parameter(s), the reference time-domain resource set including only one type of symbols of the two types of symbols.

11. A method in a first node for wireless communications, comprising:
receiving a second information block, the second information block being used to determine that a first search space set is linked to a second search space set and a third search space set; and
receiving a first information block, the first information block being used to determine a reference time-domain resource set; and
monitoring in a first time unit at least first PDCCH candidate in the first search space set and at least target PDCCH candidate in a target search space set;
wherein the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

12. The method according to claim 11, characterized in that when the first time unit belongs to the reference time-domain resource set, the target search space set is the third search space set; or, when PDCCH monitoring occasion(s) of the second search space set in the first time unit belongs/belong to the reference time-domain resource set, the target search space set is the third search space set; or, when a PDCCH monitoring occasion in which the at least first PDCCH candidate in the first search space set is monitored in the first time unit belongs to the reference time-domain resource set, the target search space set is the third search space set.

13. The method according to claim 11, characterized in that
in the first time unit, PDCCH candidates in a search space set of the second search space set and the third search space set other than the target search space set and PDCCH candidates in the first search space set are not monitored to detect a DCI format with identical information;
or,
in the first time unit, monitoring of the PDCCH candidates is dropped in a search space set of the second search space set and the third search space set other than the target search space set.

14. The method according to claim 11, characterized in that
the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set;
or,
comprising: receiving a third information block; wherein the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside the reference time-domain resource set and QCL information for a DMRS antenna port for PDCCH reception in the first CORESET in the reference time-domain resource set.

15. The method according to claim 11, characterized in that
the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission;
or,
two types of symbols are both configured as DL by higher layer parameter(s), the reference time-domain resource set including only one type of symbols of the two types of symbols.

16. A method in a second node for wireless communications, comprising:
transmitting a second information block, the second information block being used to determine that a first search space set is linked to a second search space set and a third search space set; and
transmitting a first information block, the first information block being used to determine a reference time-domain resource set;
wherein the first PDCCH candidate and the target PDCCH candidate are monitored to detect a DCI format with identical information; the target search space set is one of the second search space set or the third search space set, and whether the target search space set is the second search space set or the third search space set depends on whether the first time unit and the reference time-domain resource set are orthogonal; when the first time unit and the reference time-domain resource set are orthogonal, the target search space set is the second search space set.

17. The method according to claim 16, characterized in that when the first time unit belongs to the reference time-domain resource set, the target search space set is the third search space set; or, when PDCCH monitoring occasion(s) of the second search space set in the first time unit belongs/belong to the reference time-domain resource set, the target search space set is the third search space set; or, when a PDCCH monitoring occasion in which the at least first PDCCH candidate in the first search space set is monitored in the first time unit belongs to the reference time-domain resource set, the target search space set is the third search space set.

18. The method according to claim 16, characterized in that
in the first time unit, PDCCH candidates in a search space set of the second search space set and the third search space set other than the target search space set and PDCCH candidates in the first search space set are not monitored to detect a DCI format with identical information;
or,
in the first time unit, monitoring of the PDCCH candidates is dropped in a search space set of the second search space set and the third search space set other than the target search space set.

19. The method according to claim 16, characterized in that
the second information block comprises configuration information of the first search space set, configuration information of the second search space set and configuration information of the third search space set; the configuration information of the first search space set includes two first-type parameters, the configuration information of the second search space set includes at least one first-type parameter, and the configuration information of the third search space set includes at least one first-type parameter, and the two first-type parameters included in the configuration information of the first search space set respectively have the same values as one first-type parameter in the configuration information of the second search space set and one first-type parameter in the configuration information of the third search space set;
or,
comprising: transmitting a third information block; wherein the third information block indicates configuration information of a first CORESET; the first CORESET is associated with the first search space set, and the configuration information of the first CORESET includes two TCI states; the two TCI states in the configuration information of the first CORESET respectively indicate QCL information for a DMRS antenna port for PDCCH reception in the first CORESET outside the reference time-domain resource set and QCL information for a DMRS antenna port for PDCCH reception in the first CORESET in the reference time-domain resource set.

20. The method according to claim 16, characterized in that
the reference time-domain resource set comprises one or more symbols, and at least one symbol in the reference time-domain resource set is configured as DL by a higher layer parameter, and one or more subcarriers in one or more symbols in the reference time-domain resource set configured as DL by the higher layer parameter is/are used for uplink transmission;
or,
two types of symbols are both configured as DL by higher layer parameter(s), the reference time-domain resource set including only one type of symbols of the two types of symbols.
